(19) United States
(12) Patent Application Publication
(10) Pub. No.: US 2024/0121519 A1
(43) Pub. Date: Apr. 11, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventors: KOJI KAMIYA, TOKYO (JP); WATARU TOISHITA, TOKYO (JP)

(21) Appl. No.: 18/263,549

(22) PCT Filed: Dec. 29, 2021
(86) PCT No.: PCT/JP2021/048921

§ 371 Date: Jul. 31, 2023

(30) Foreign Application Priority Data
Feb. 9, 2021 (JP) 2021-018743

(51) Int. Cl. H04N 23/75; H04N 23/661; H04N 23/88

(52) U.S. Cl. CPC H04N 23/75; H04N 23/661; H04N 23/88

(57) ABSTRACT

The present disclosure relates to an information processing device, an information processing method, and a program capable of improving the operability in remote control of a video camera via a network. A control signal for remote control is transmitted to the video camera via a network, and an adjusted image is acquired in which an adjustment corresponding to the control signal is made on a captured image captured by the video camera. A reverse adjustment to the adjustment corresponding to the control signal is made on the acquired adjusted image to restore the captured image, and an adjustment corresponding to a real-time control signal is made on the restored captured image. This can be applied to remote control of the video camera via the network.

### TECHNICAL FIELD

The present disclosure relates to an information processing device, an information processing method, and a program, and particularly to an information processing device, an information processing method, and a program capable of improving the operability in remote control via a network.

### BACKGROUND ART

A technology has been proposed for providing remote control through a cable by which a video camera and a controller are connected to each other (see PTL 1).

### CITATION LIST

### Patent Literature

[PTL 1]
JP H5-064048A

### SUMMARY

### Technical Problem

In recent years, remote control technology has made further progress, and a technology has been provided in which a video camera and a controller are connected via a network so that the controller remotely controls the video camera.

However, when a video camera and a controller are connected via a network, delays may occur and control signals may be lost due to the conditions on the network, possibly preventing the intended remote control and therefore reducing the operability.

The present disclosure has been made in view of such circumstances, in particular, in order to improve the operability in remote control via a network.

### Solution to Problem

An information processing device and a program according to one aspect of the present disclosure are an information processing device and a program therefor, the information processing device including: a reverse adjustment unit that makes on an adjusted image in which an adjustment is made on a captured image captured by an imaging device for capturing the captured image, a reverse adjustment to the adjustment to restore the captured image before the adjustment; and an adjustment unit that makes an adjustment on the restored captured image.

An information processing method according to one aspect of the present disclosure is an information processing method includes a step of making on an adjusted image in which an adjustment is made on a captured image captured by an imaging device for capturing the captured image, a reverse adjustment to the adjustment to restore the captured image before the adjustment, and making an adjustment on the restored captured image.

According to one aspect of the present disclosure, on an adjusted image in which an adjustment is made on a captured image captured by an imaging device for capturing the captured image, a reverse adjustment to the adjustment is made to restore the captured image before the adjustment, and an adjustment is made on the restored captured image.

### BRIEF DESCRIPTION OF DRAWINGS

FIG. 1 is a diagram illustrating a configuration of a control system that implements remote control.

FIG. 2 is a diagram illustrating a configuration of a control system that implements remote control via a network.

FIG. 3 is a diagram illustrating an overview of the present disclosure.

FIG. 4 is a diagram illustrating a configuration example of a control system according to a first embodiment of the present disclosure.

FIG. 5 is a diagram illustrating a configuration example of an adjustment unit of FIG. 4.

FIG. 6 is a diagram illustrating a configuration example of a reverse adjustment unit of FIG. 4.

FIG. 7 illustrates control processing performed by the control system of FIG. 4.

FIG. 8 is a diagram illustrating a configuration example of a control system according to a second embodiment of the present disclosure.

FIG. 9 illustrates control processing performed by the control system of FIG. 8.

FIG. 10 is a diagram illustrating a configuration example of a control system according to a third embodiment of the present disclosure.

FIG. 11 illustrates control processing performed by the control system of FIG. 10.

FIG. 12 is a diagram illustrating a configuration example of a control system according to a fourth embodiment of the present disclosure.

FIG. 13 illustrates control processing performed by the control system of FIG. 12.

FIG. 14 is a diagram illustrating a configuration example of a control system according to a first application example of the present disclosure.

FIG. 15 is a diagram illustrating a configuration example of a control system according to a second application example of the present disclosure.

FIG. 16 is a diagram illustrating a configuration example of a control system according to a third application example of the present disclosure.

FIG. 17 is a diagram illustrating a configuration example of a control system according to a fourth application example of the present disclosure.

FIG. 18 is a diagram illustrating a configuration example of a control system according to a fifth application example of the present disclosure.

FIG. 19 is a diagram illustrating a configuration example of a control system according to a fifth embodiment of the present disclosure.

FIG. 20 is a diagram illustrating a configuration example of a control unit of a TAU of FIG. 19.

FIG. 21 is a diagram illustrating a configuration example of a gain control unit of FIG. 19.

FIG. 22 illustrates control processing performed by the control system of FIG. 19.

FIG. 23 is a diagram illustrating a first modification example of the gain control unit in FIG. 19.

FIG. 24 is a diagram illustrating a second modification example of the gain control unit in FIG. 19.

FIG. 25 is a diagram illustrating a configuration example of a general-purpose personal computer.

### DESCRIPTION OF EMBODIMENTS

Preferred embodiments of the present disclosure will be described below in detail with reference to the accompanying drawings. In the present specification and drawings, components having substantially the same functional configuration are denoted by the same reference signs, and repeated description thereof will be omitted.

An embodiment for implementing the present technology will be described below. The description will be made in the following order.
1. Overview of Present Disclosure
2. First Embodiment
3. Second Embodiment
4. Third Embodiment
5. Fourth Embodiment
6. First Application Example
7. Second Application Example
8. Third Application Example
9. Fourth Application Example
10. Fifth Application Example
11. Fifth Embodiment
12. First Modification Example of Fifth Embodiment
13. Second Modification Example of Fifth Embodiment
14. Software-performed Example

### 1. Overview of Present Disclosure

<Control System Implementing Remote Control>

In particular, the present disclosure aims at improving the operability in remote control via a network.

First, a control system that realizes remote control will be described.

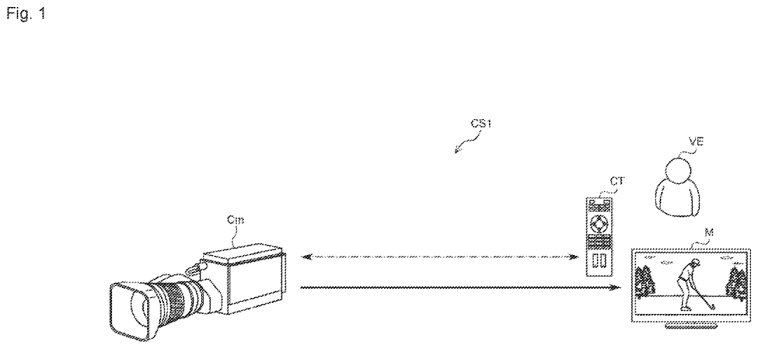

FIG. 1 illustrates a configuration example of a control system for remotely controlling a video camera by means of a controller connected to the video camera wired or wirelessly.

The control system CS1 in FIG. 1 includes a video camera Cm, a controller CT, and a monitor M.

The controller CT is operated by an operator VE who controls the video camera Cm for image capture, and transmits a control signal according to an operation to the video camera Cm through wired communication.

The video camera Cm includes an image sensor including CMOS (Complementary Metal Oxide Semiconductor) or the like, captures an image as a captured image, and then makes on the captured image an adjustment based on the control signal transmitted from the controller CT to generate an adjusted image.

Based on the control signal supplied from the controller CT, the video camera Cm generates the adjusted image by adjusting the black offset and gamma characteristics of the captured image, and outputs the adjusted image to the monitor M connected wired for display of the adjusted image as an image.

In the figure, the control signal to be transmitted from the controller CT to the video camera Cm is represented by dashed-dotted line arrows, and the adjusted image output from the video camera Cm to the monitor M is represented by a solid line arrow.

In FIG. 1, the video camera Cm, the controller CT, and the monitor M are connected by a single cable capable of exchanging control signals and adjusted images, for example.

With the configuration as illustrated in FIG. 1, the operator VE can control the video camera Cm in real time by operating the controller CT while viewing the image displayed on the monitor M.

<Control System Via Network>

However, in recent years, a technology has been proposed in which a video camera Cm, a controller CT and a monitor M are connected via a network so that even an operator VE who is far away from the video camera Cm can remotely control the video camera Cm.

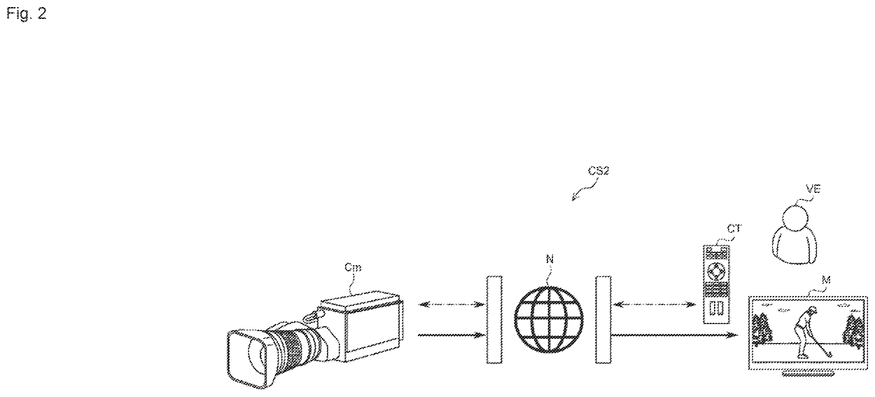

Specifically, in a control system CS2 as illustrated in FIG. 2, the video camera Cm, the controller CT, and the monitor M are connected via a network N, so that the operator VE can remotely control the video camera Cm even in a remote environment.

However, with the configuration of the control system CS2 as illustrated in FIG. 2, the control signal transmitted from the controller CT to the video camera Cm is supplied via the network N, which may cause a delay and the loss of the control signal.

In addition, the adjusted image, which has been adjusted based on the control signal and is supplied by the video camera Cm, is supplied to the monitor M via the network N, which may cause a further delay and the loss of image data.

As a result, when an operator VE performs an operation on the controller CT while viewing the image displayed on the monitor M, the adjustment details based on the control signal transmitted according to the operation are reflected in the image displayed on the monitor M in real time, so that the operability may be reduced.

<Operation System of Present Disclosure>

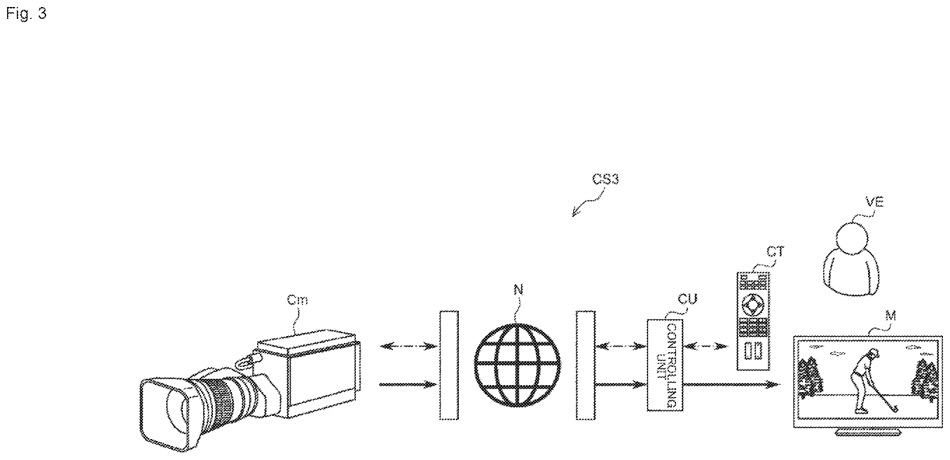

Therefore, in the present disclosure, a controlling unit CU is provided between a controller CT, a monitor M, and a network N, in a control system CS3 as illustrated in FIG. 3.

The controlling unit CU removes the adjustment made by a video camera Cm on an adjusted image transmitted from the video camera Cm via the network N, thereby restoring the captured image before the adjustment.

Then, the controlling unit CU performs an adjustment on the restored captured image in real time based on a control signal from the controller CT to generate an adjusted image, and outputs the adjusted image to the monitor M for display.

As a result, an adjustment to be made on a captured image by an operator VE, who is viewing an image displayed on the monitor M, in response to a control signal generated according to an operation on the controller CT will be made on the capture image that is restored in real time within the controlling unit CU.

As a result, delays and losses caused by transmission and reception of control signals via the network N are suppressed, so that it is possible to improve the operability in remote control of the video camera Cm using the controller CT.

### 2. First Embodiment

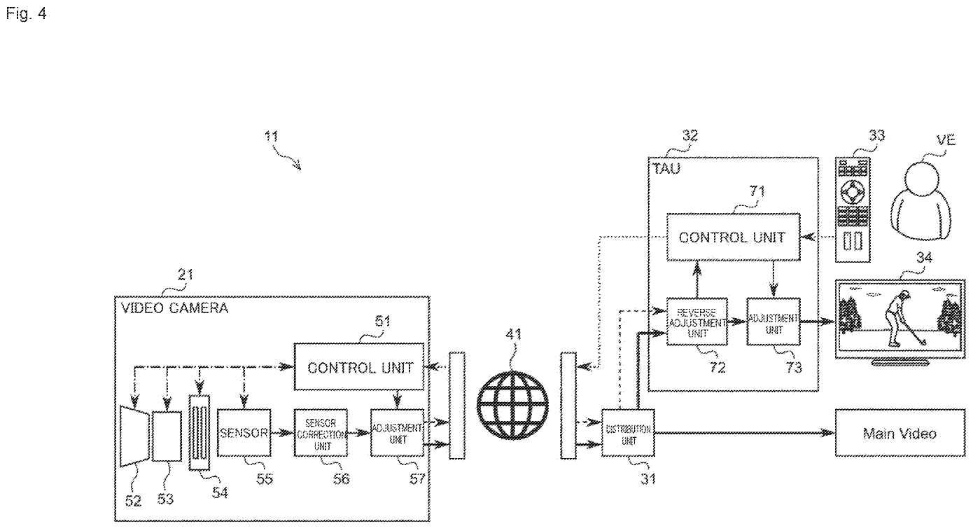

Next, a configuration example of a first embodiment of a control system of the present disclosure will be described with reference to FIG. 4.

The control system 11 of FIG. 4 includes a video camera 21, a distribution unit 31, a telecontrol assist unit (TAU) 32, a controller 33, and a monitor 34. The control system 11 of FIG. 4 is configured to control (remotely control) the video camera 21 provided at a remote location by operating the controller 33. In FIG. 4, the TAU 32 is a component corresponding to the controlling unit CU in FIG. 3.

The video camera 21, the distribution unit 31, the TAU 32, the controller 33, and the monitor 34 are connected via a network 41 represented by the Internet.

The left side from the network 41 in the figure is a configuration of a space where an image is to be captured by the video camera 21.

The configuration of the distribution unit 31, the TAU 32, the controller 33, and the monitor 34 on the right side from network 41 in the figure is a configuration of a space where an operator VE who views an image captured by the video camera 21 or controls the video camera 21 is located.

The controller 33 includes operation buttons, various switches, and the like, and when operated by the operator VE, generates a control signal corresponding to the operation and supplies the control signal to the TAU 32. The controller 33 and the TAU 32 may be connected to each other, for example, wired by a dedicated cable connection, or may be configured to exchange data and information through short-range communication such as infrared communication or Bluetooth (registered trademark) communication.

The TAU 32 supplies the control signal supplied from the controller 33 to the video camera 21 via the network 41.

When the video camera 21 acquires a control signal corresponding to an operation of the operator VE on the controller 33 via the TAU 32 and the network 41, the video camera 21 generates, according to the control signal, camera adjustment value data for setting an adjustment to be made on the captured image.

The video camera 21 captures an image composed of RGB linear signals as a captured image, generates an adjusted image by making the adjustment according to the camera adjustment value data, and transmits the adjusted image along with the camera adjustment value data to the controlling unit 32 via the network 41 and the distribution unit 31. This camera adjustment value data may be attached to the adjusted image as metadata of the digital video signal.

The distribution unit 31 outputs the adjusted image and the camera adjustment value data, which are supplied from the video camera 21 via the network 41 to the TAU 32, and also distributes the adjusted image to be output as a main video.

The TAU 32 generates a TAU control signal corresponding to the control signal, which is supplied from the controller 33, and based on the TAU control signal, restores the adjusted image, which is supplied from the video camera 21, to an image close to the captured image before the adjustment. The TAU 32 makes an adjustment on the restored image based on the TAU control signal and outputs the resulting image to the monitor 34 for display.

More specifically, the video camera 21 includes a control unit 51, an optical block 52, a diaphragm adjustment unit 53, a filtering unit 54, a sensor 55, a sensor correction unit 56, and an adjustment unit 57.

The control unit 51 includes a processor and a memory, and controls the overall operation of the video camera 21.

The control unit 51 generates based on the control signal according to the operation of the operator VE on the controller 33, which is transmitted from the TAU 32 via the network 41, camera adjustment value data for setting the adjustment details to be made on the captured image composed of RGB linear signals, and supplies the camera adjustment value data to the adjustment unit 57.

The control unit 51 controls the optical block 52, the diaphragm adjustment unit 53, the filtering unit 54, and the sensor 55 to capture a captured image.

The optical block 52 includes a plurality of lenses and is controlled by the control unit 51 to adjust the focal position so that the light from the subject is focused on the sensor 55.

The diaphragm adjustment unit 53 is controlled by the control unit 51 to adjust the amount of light incident from the optical block 52.

The filtering unit 54 includes a variable neutral density (ND) filter, a color compensating (CC) filter, and others, and executes various filtering under the control of the control unit 51.

The sensor 55 includes, for example, a complementary metal oxide semiconductor (CMOS) image sensor and others, generates an image composed of pixel signals according to the amount of incident light, and outputs the image to the sensor correction unit 56.

In other words, the sensor 55 captures an image corresponding to the incident light that has passed through the optical block 52, the diaphragm adjustment unit 53, and the filtering unit 54, and outputs the image to the sensor correction unit 56 as a captured image composed of RGB linear signals.

The sensor correction unit 56 is configured to have various correction functions for the sensor 55, and for example, performs flaw correction, noise suppression, and shading correction on the captured image captured by sensor 55, and outputs the resulting image to the adjustment unit 57.

Based on the camera adjustment value data supplied from the control unit 51, the adjustment unit 57 performs gain adjustment, black correction, compression (such as high-luminance compression), characteristic adjustment (such as gamma curve adjustment), and format conversion on the captured image, and outputs the resulting image as an adjusted image to the TAU 32 via the network 41 and the distribution unit 31.

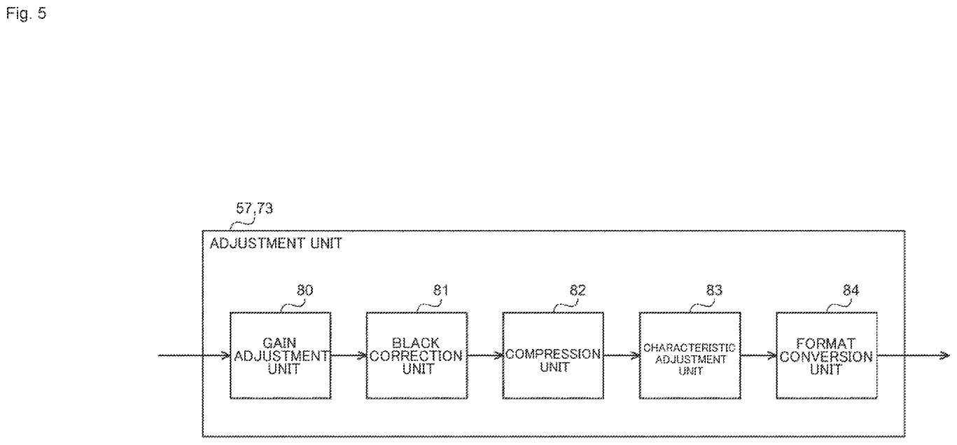

The configuration of the adjustment unit 57 will be described later in detail with reference to FIG. 5.

The TAU 32 includes a control unit 71, a reverse adjustment unit 72 and an adjustment unit 73.

The control unit 71 includes a processor and a memory, and controls the overall operation of the TAU 32.

The control unit 71 outputs the control signal supplied from the controller 33 to the video camera 21 via the network 41.

Based on the control signal supplied from the controller 33, the control unit 71 sets in the adjustment unit 73 a TAU control signal for setting adjustment details to be made on an image close to a captured image in which the adjustment made on the adjusted image based on the camera adjustment value data by the reverse adjustment unit 72 is removed. The control unit 71 outputs the set TAU control signal to the adjustment unit 73.

Based on the adjusted image and the camera adjustment value data, which are supplied from the video camera 21, the reverse adjustment unit 72 removes the adjustment made on the adjusted image to restore an image close to the captured image output from the sensor correction unit 56, and outputs the image to the adjustment unit 73.

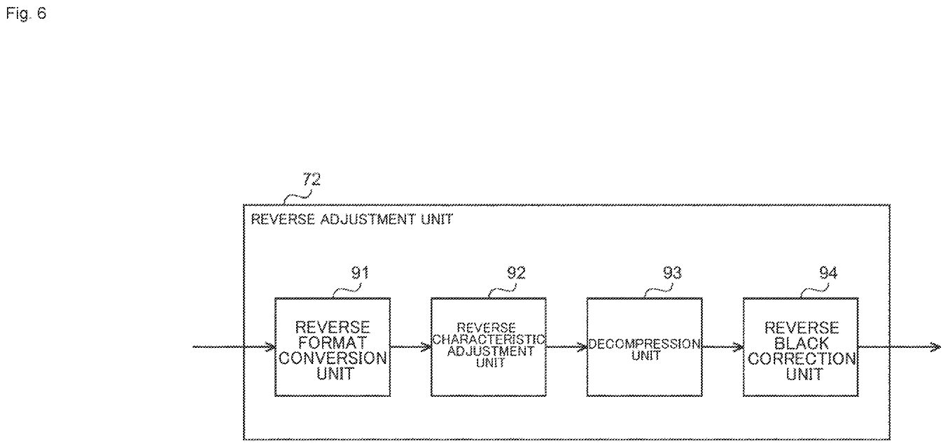

The configuration of the reverse adjustment unit 72 will be described later in detail with reference to FIG. 6.

Based on the TAU control signal supplied from the control unit 71, the adjustment unit 73 makes an adjustment on the image close to the captured image output from the sensor correction unit 56 to generate an adjusted image, and outputs the resulting image to the monitor 34 for display.

The configuration of the adjustment unit 73 is basically the same as that of the adjustment unit 57, and the configuration of the reverse adjustment unit 72 is a configuration in which reverse processing to the processing to be performed on an image is performed by the adjustment units 57 and 73.

Thus, the TAU 32 supplies the control signal supplied from the controller 33 to the video camera 21.

The video camera 21 generates camera adjustment value data in response to the control signal, and makes an adjustment corresponding to the camera adjustment value data on the captured image captured to generate an adjusted image.

The TAU 32 acquires the adjusted image thus generated by the video camera 21 and the camera adjustment value data via the network 41 and the distribution unit 31.

Based on the acquired camera adjustment value data, the TAU 32 removes the adjustment made on the adjusted image to restore an image close to the captured image, generates a TAU control signal corresponding to the control signal, and makes an adjustment on the image close to the captured image based on the generated TAU control signal.

With such a configuration, the adjusted image supplied from the remote video camera 21 via the network 41 is restored to an image close to the captured image before being adjusted using the camera adjustment value data, and then adjusted using the TAU control signal based on the control signal supplied in real time. Then, an adjusted image in which the adjustment is made on the restored image close to the captured image by using the TAU control signal is output to the monitor 34 for display.

Thus, in the TAU 32, the adjustment based on the TAU control signal corresponding to the control signal generated in response to an operation of the operator VE on the controller 33 will be made on the restored captured image supplied from the video camera 21.

As a result, delays and losses caused by the supply of the control signal to the video camera 21 via the network 41 can be suppressed, so that it is possible to improve the operability in remote control of the video camera 21 using the controller 33 via the network 41.

<Configuration Example of Adjustment Unit>

Next, a configuration example of the adjustment units 57 and 73 will be described with reference to FIG. 5.

The adjustment units 57 and 73 each include a video gain adjustment unit 80, a black correction unit 81, a compression unit 82, a characteristic adjustment unit 83, and a format conversion unit 84.

The video gain adjustment unit 80 adjusts the video gain for the captured image, which is supplied from the sensor 55, or of the RGB linear image signal close to the captured image, which is supplied from the reverse adjustment unit 72, and outputs the resulting image to the black correction unit 81.

The black correction unit 81 adjusts the black offset of the image whose gain has been adjusted by the video gain adjustment unit 80, and outputs the resulting image to the compression unit 82.

The compression unit 82 performs luminance level compression or the like according to a video level on the image whose black offset has been adjusted, and supplies the video as the result of adjustment to the characteristic adjustment unit 83.

The characteristic adjustment unit 83 performs luminance adjustment based on a transfer function on the image whose luminance has been compressed for adjustment according to the video level, and outputs the resulting image to the format conversion unit 84.

More specifically, the characteristic adjustment unit 83 uses for high dynamic range (HDR) signals the opto-electronic transfer function (OETF) as a transfer function, and uses for standard dynamic range (SDR) signals the gamma function as a transfer function, to adjust the characteristics related to color and gradation.

The format conversion unit 84 converts a “444” of RGB linear signal into a “422” of Y color difference signal, and outputs them.

Thus, a series of adjustment processing through the video gain adjustment unit 80, the black correction unit 81, the compression unit 82, the characteristic adjustment unit 83, and the format conversion unit 84 of the adjustment units 57 and 73 is performed on the captured image supplied from the sensor correction unit 56 to generate an adjusted image. The adjustment details of the video gain adjustment unit 80, the black correction unit 81, the compression unit 82, the characteristic adjustment unit 83, and the format conversion unit 84 change based on the camera adjustment value data and the TAU control signal.

<Configuration Example of Reverse Adjustment Unit>

Next, a configuration example of the reverse adjustment unit 72 will be described with reference to FIG. 6.

The reverse adjustment unit 72 includes a reverse format conversion unit 91, a reverse characteristic adjustment unit 92, a decompression unit 93, and a reverse black correction unit 94.

The reverse format conversion unit 91 converts the “422” Y color difference signal into the “444” RGB signal, and outputs the “444” RGB signal to the reverse characteristic adjustment unit 92.

The reverse characteristic adjustment unit 92 removes the luminance adjustment based on the transfer function and outputs the result to the decompression unit 93.

More specifically, the reverse characteristic adjustment unit 92 removes the luminance adjustment in which for high dynamic range (HDR) signals the opto-electronic transfer function (OETF) is used as the transfer function, and removes the luminance adjustment in which for standard dynamic range (SDR) signals the gamma function is used as the transfer function.

The decompression unit 93 performs decompression processing corresponding to the luminance compression processing performed according to the video level, and supplies the result of decompression to the reverse black correction unit 94.

The reverse black correction unit 94 removes the black offset that has been intentionally added, and outputs the result as an image close to the corrected captured image supplied from the sensor correction unit 56.

Thus, a series of reverse adjustment processing through the reverse format conversion unit 91, the reverse characteristic adjustment unit 92, the decompression unit 93, and the reverse black correction unit 94 of the reverse adjustment unit 72 is performed on the adjusted image to remove the adjustment made by the adjustment unit 57 and thus to generate an image close to the (corrected) captured image before the adjustment.

The decompression processing for the high-luminance compression in the decompression unit 93 cannot completely restore the state before the compression. Therefore, even if the reverse adjustment unit 72 performs the series of reverse adjustment processing on the adjusted image, the captured image is not completely restored, but an image close to the (corrected) captured image is restored.

Hereinafter, an image that is close to the captured image restored from the adjusted image after the adjusted image is reversely adjusted by the reverse adjustment unit 72 is also simply referred to as a restored captured image.

Thus, the image restored by the reverse adjustment unit 72 to perform the reverse adjustment on the adjusted image is an image close to the captured image, and strictly speaking, it is not the same image as the captured image. However, for convenience of explanation, a description will be given here assuming that the captured image is restored.

<Control Processing Performed by Control System of FIG. 4>

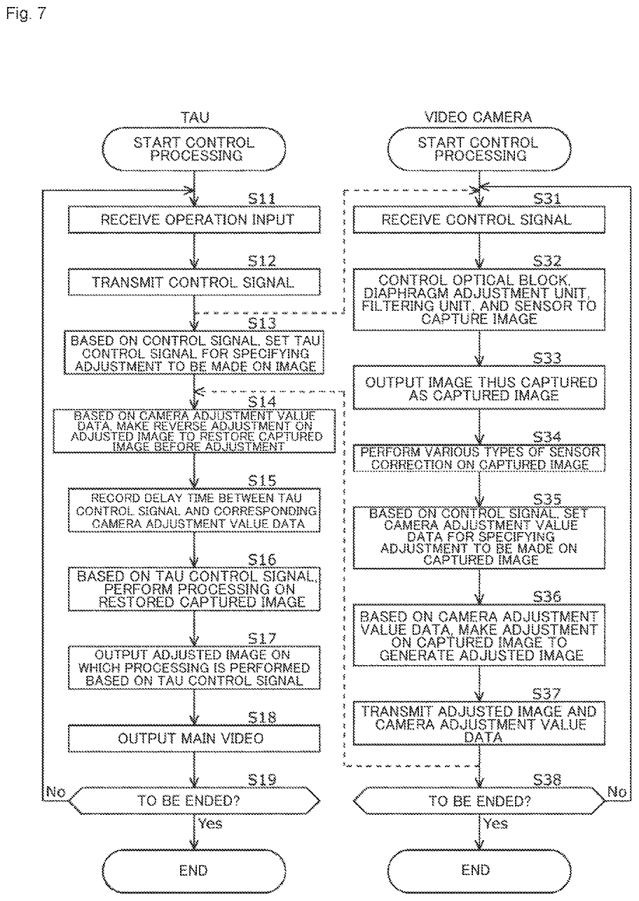

Next, control processing performed by the control system of FIG. 4 will be described with reference to the flowchart of FIG. 7.

In step S11, in response to receiving an operation input from the operator VE, the controller 33 generates a corresponding control signal, and outputs the control signal to the TAU 32.

In step S12, the control unit 71 of the TAU 32 transmits the control signal supplied from the controller 33 to the video camera 21 via the network 41.

In step S13, the control unit 71 generates a TAU control signal for setting adjustment details to be made on the image based on the control signal, and outputs the TAU control signal to the adjustment unit 73.

On the other hand, in step S31, the control unit 51 of the video camera 21 receives the control signal transmitted from the TAU 32 via the network 41.

In step S32, the control unit 51 controls the optical block 52, the diaphragm adjustment unit 53, the filtering unit 54, and the sensor 55 to capture an image.

In step S33, the control unit 51 controls the sensor 55 to output the image thus captured as a captured image to the sensor correction unit 56.

In step S34, the sensor correction unit 56 performs flaw correction, noise suppression, shading correction, and the like on the captured image, and outputs the resulting image to the adjustment unit 57.

In step S35, based on the control signal supplied from the TAU 32, the control unit 51 sets camera adjustment value data for setting adjustment details to be made on the captured image, and outputs the data to the adjustment unit 57.

In step S36, based on the camera adjustment value data supplied from the control unit 51, the adjustment unit 57 makes on the corrected captured image an adjustment including black offset, compression, characteristic adjustment, and format conversion to generate an adjusted image.

In step S37, the adjustment unit 57 transmits the generated adjusted image together with the camera adjustment value data to the distribution unit 31 via the network 41.

Among the transmitted adjusted image and camera adjustment value data, the distribution unit 31 outputs the adjusted image as it is as a main video, and distributes the adjusted image and camera adjustment value data to be output to the TAU 32.

In step S14, based on the camera adjustment value data, the reverse adjustment unit 72 of the TAU 32 makes on the adjusted image a reverse adjustment including reverse format conversion, reverse characteristic adjustment, black offset removal, and decompression to restore the captured image, and outputs the resulting captured image to the adjustment unit 73. At this time, the reverse adjustment unit 72 outputs the camera adjustment value data to the control unit 71.

In step S15, the control unit 71 obtains a delay time from the correspondence between the TAU control signal generated by itself and the camera adjustment value data supplied from the reverse adjustment unit 72.

As a result, the delay time between the TAU control signal and the corresponding camera adjustment value data gives an indication of the amount of time required between the supply of the control signal from the TAU 32 to the video camera 21 via the network 41 and the transmission of the corresponding adjusted image from the video camera 21 via the network 41.

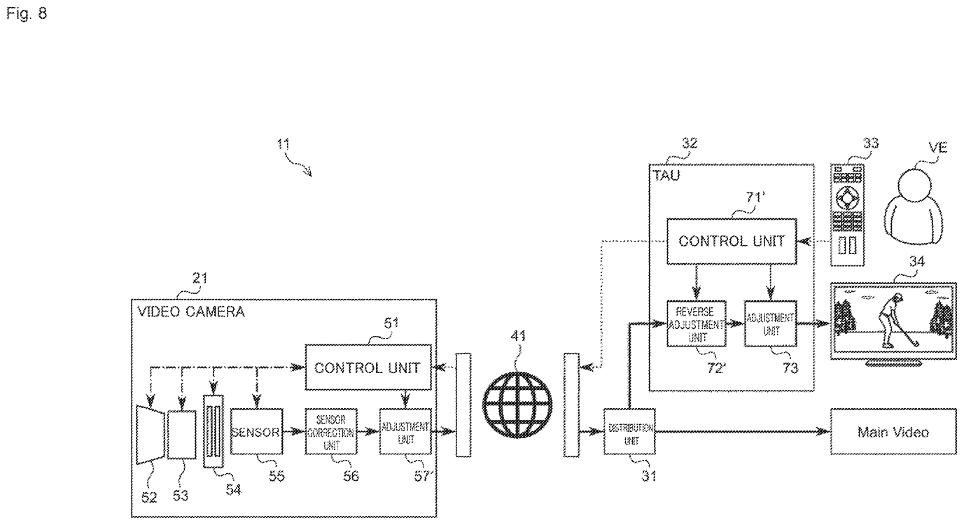

This delay time is not used in the control processing described with reference to the flowchart of FIG. 7, and therefore the processing of step S15 may be omitted. However, the delay time is information that can be used in a configuration described later with reference to FIG. 8, and is therefore given here as an example of a method of acquiring the delay time.

In step S16, the adjustment unit 73 makes an adjustment on the restored captured image based on the TAU control signal to generate an adjusted image.

In step S17, the adjustment unit 73 outputs the adjusted image to the monitor 34 for display.

In step S18, the adjusted image, which is supplied from the video camera 21, distributed by the distribution unit 31 is output as a main video.

In steps S19 and S38, it is determined whether or not an instruction to end the processing has been given, and if no instruction to end the processing has been given, the processing returns to steps S11 and S31, respectively. Accordingly, until an instruction to end the processing is given, the TAU 32 including the distribution unit 31 repeats the processing of steps S11 to S19, and the video camera 21 repeats the processing of steps S31 to S38.

Then, in steps S19 and S38, if the instruction to end is given, the processing ends.

Through the above processing, when the operator VE performs an operation on the controller 33, a control signal corresponding to the operation is generated, supplied to the TAU 32, and supplied to the video camera 21 via the network 41. Meanwhile, the TAU 32 generates a TAU control signal based on the control signal.

The video camera 21 generates camera adjustment value data based on the control signal, captures an image, and generates an adjusted image in which adjustment processing based on the camera adjustment value data is performed on the captured image thus captured.

Then, the adjusted image generated by the video camera 21 is transmitted together with the camera adjustment value data to the TAU 32 via the network 41.

The TAU 32 makes the reverse adjustment based on the camera adjustment value data on the adjusted image generated by the video camera 21 to restore the captured image, and makes the adjustment based on the TAU control signal on the restored captured image, and the resulting image as an adjusted image is then displayed on the monitor 34.

Thus, the TAU 32 makes it possible to make the adjustment, which is based on the TAU control signal corresponding to the control signal according to the operation on the controller 33, directly on the captured image (restored captured image) before being adjusted according to the control signal in the video camera 21.

As a result, a control signal generated by the operator VE operating the controller 33 is converted into a TAU control signal in the TAU 32, and the adjustment processing based on the TAU control signal is then performed directly on the captured image (restored captured image).

Further, even when the controller 33 is used to remotely control the video camera 21 via the network 41, delays and losses of control signals can be suppressed for adjustments made on an image captured by the video camera 21 and thus to improve the operability.

As a result, even when the video camera 21 is remotely controlled via the network 41, the operator VE can operate the controller 33 while viewing the image captured by the video camera 21 on the monitor 34, thereby making an appropriate adjustment on the captured image.

When there is a difference between a value set by the operator VE and the adjustment state of the camera, the TAU 32 may compensate for the difference. In such a case, the user is presented with information indicating that there is a difference between a value set by the operator VE and the adjusted state of the camera, and that the TAU 32 has corrected the difference between them. As the information indicating that the TAU 32 has corrected the difference between them, for example, a predetermined lamp indicating that information may be turned on, or a predetermined mark indicating that information may be displayed in the video image.

### 3. Second Embodiment

An example has been described above in which a camera adjustment value data signal is transmitted from the video camera 21 together with an adjusted image to the TAU 32, and the reverse adjustment is made on the adjusted image based on the camera adjustment value data signal to restore the captured image.

However, if the adjusted image can be transmitted to the TAU 32 but the camera adjustment value data cannot be transmitted due to the configuration of the video camera 21 or communication conditions on the network 41, the TAU 32 may use the delay time to restore the captured image based on the TAU control signal.

FIG. 8 illustrates a configuration example of a control system 11 in a case where an adjusted image can be transmitted to the TAU 32 but camera adjustment value data cannot be transmitted due to the configuration of the video camera 21 or communication conditions on the network 41.

In the control system 11 of FIG. 8, components having the same functions as those of the control system 11 of FIG. 4 are denoted by the same reference signs, and description thereof will be omitted as appropriate.

Specifically, the configuration of the control system 11 of FIG. 8 differs from the configuration of the control system 11 of FIG. 4 in that an adjustment unit 57′, a control unit 71′, and a reverse adjustment unit 72′ are provided instead of the adjustment unit 57, the control unit 71, and the reverse adjustment unit 72.

The adjustment unit 57′ has the same basic functions as the adjustment unit 57 and can transmit the adjusted image to the TAU 32 via the network 41 and the distribution unit 31. However, the adjustment unit 57′ cannot transmit the camera adjustment value data.

The control unit 71′ has the same basic functions as the control unit 71. However, the control unit 71′ transmits a control signal and then supplies to the reverse adjustment unit 72′ a TAU control signal corresponding to the control signal at a timing corresponding to the delay time of the adjusted image transmitted from the video camera 21. For example, the control unit 71′ may store the TAU control signal in association with the control signal for a predetermined time in time series, and output the TAU control signal at the time going back by the delay time to the reverse adjustment unit 72′.

The reverse adjustment unit 72′ has the same basic function as the reverse adjustment unit 72. However, the reverse adjustment unit 72′ reversely adjusts the adjusted image to restore the captured image, based on the TAU control signal supplied from the control unit 71, instead of the camera adjustment value data supplied from the video camera 21.

The term “delay time” as used herein refers to, for example, a latency between the time at which the TAU control signal to be supplied from the control unit 71, which is obtained in the processing of step S16 in the flowchart of FIG. 7 described above, is supplied and the time at which the corresponding camera adjustment value data is acquired.

As a result, the delay time between the TAU control signal and the corresponding camera adjustment value data gives an indication of the amount of time required between the supply of the control signal from the TAU 32 to the video camera 21 via the network 41 and the transmission of the corresponding adjusted image from the video camera 21 via the network 41.

Therefore, even when no camera adjustment value data corresponding to the adjusted image is acquired, the reverse adjustment unit 72′ can restore the captured image from the adjusted image by using the TAU control signal corresponding to the control signal transmitted to the video camera 21 at the time going back by the delay time.

FIG. 8 also illustrates an example of a case where the camera adjustment value data cannot be transmitted from the video camera 21 to the TAU 32 via the network 41.

Therefore, for example, with a configuration in which the adjustment unit 57 is provided, even when an adjusted image and camera adjustment value data are transmitted but the camera adjustment value data is lost due to a communication failure or the like on the network 41, the control unit 71′ and the reverse adjustment unit 72′ can perform the above-described processing.

<Control Processing Performed by Control System of FIG. 8>

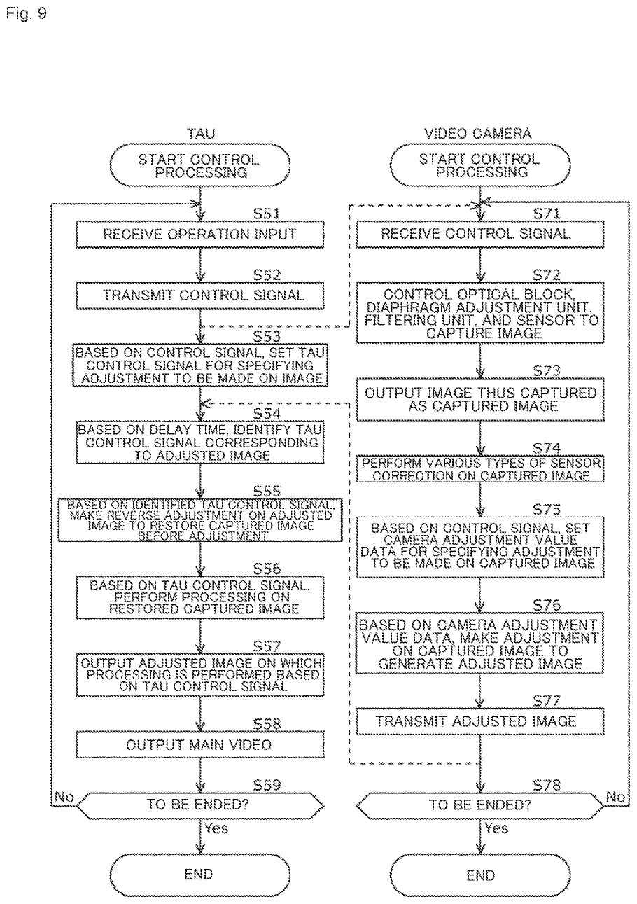

Next, control processing performed by the control system of FIG. 8 will be described with reference to the flowchart of FIG. 9.

The processing of steps S51 to S53 and S56 to S59 and the processing of steps S71 to S76 and S78 in the flowchart of FIG. 9 are the same as the processing of steps S11 to S13 and S16 to S19 and the processing of steps S31 to S36 and S38 in the flowchart of FIG. 7, and therefore description thereof will be omitted.

Specifically, when an adjusted image is generated by the video camera 21 through the processing of steps S51 to S53 and S71 to S76, the processing proceeds to step S77.

In step S77, the adjustment unit 57′ transmits the generated adjusted image to the TAU 32 via the network 41 and the distribution unit 31.

The distribution unit 31 distributes and outputs the transmitted adjusted image as it is as a main video, and distributes the adjusted image to be output to the TAU 32.

In step S54, the control unit 71′ of the TAU 32 identifies a TAU control signal that specifies the adjustment details to be made on the captured image corresponding to the control signal transmitted to the video camera 21 via the network 41 at the time going back by the delay time, and outputs the TAU control signal to the reverse adjustment unit 72′.

In step S55, based on the TAU control signal supplied from the control unit 71′, the reverse adjustment unit 72′ of the TAU 32 makes the reverse adjustment on the adjusted image to restore the captured image, and transmits the captured image to the adjustment unit 73.

Through the processing described above, the TAU 32 can restore the image captured by the video camera 21 even when no camera adjustment value data is supplied from the video camera 21 to the TAU 32.

As a result, even when no camera adjustment value data is supplied from the video camera 21 to the TAU 32, it is possible to improve the operability on the controller 33 for the operator VE.

### 4. Third Embodiment

An example has been described above in which no camera adjustment value data is supplied from the video camera 21 to the TAU 32.

However, if camera adjustment value data is supplied from the video camera 21 to the TAU 32 together with an adjusted image, the TAU 32 can restore the image captured by the video camera 21 even with a configuration in which no control signal is supplied from the TAU 32 or when no control signal is supplied from the TAU 32.

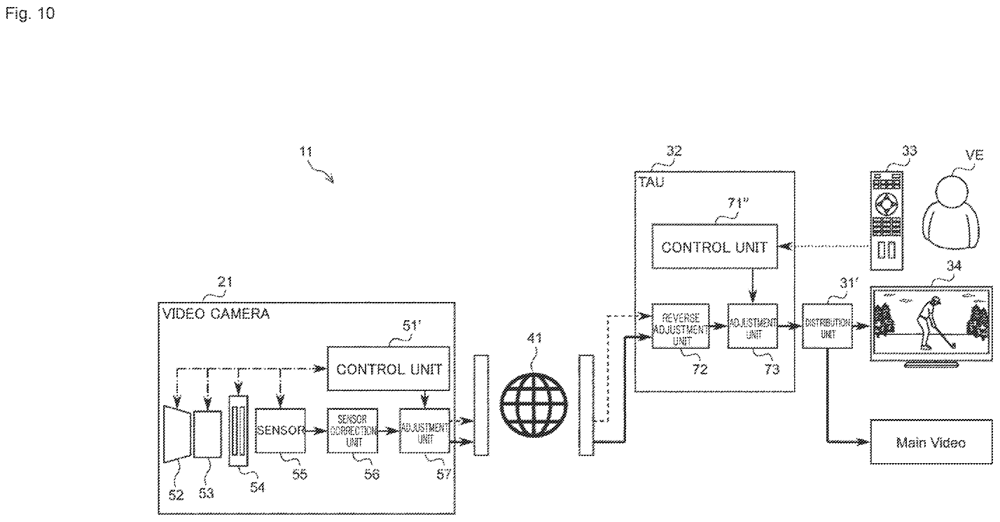

FIG. 10 illustrates a configuration example of a control system 11 having a configuration in which camera adjustment value data is supplied from the video camera 21 to the TAU 32 together with an adjusted image, but no control signal is supplied from the TAU 32, or of the control system 11 when a control signal cannot be supplied due to conditions on the network 41 or the like.

The control system 11 of FIG. 10 differs from the control system 11 of FIG. 4 in that a distribution unit 31′, a control unit 51′, and a control unit 71″ are provided instead of the distribution unit 31, the control unit 51, and the control unit 71.

The control unit 51′ has the same basic functions as the control unit 51. However, the control unit 51′ does not receive a control signal from the TAU 32 via the network 41, and supplies camera adjustment value data corresponding to a general control signal to the adjustment unit 57 to make an adjustment on a captured image. The general control signal may be set as desired.

The control unit 71″ has the same basic functions as the control unit 71, and differs in that it does not supply a control signal to the video camera 21 via the network 41.

The distribution unit 31′ outputs the adjusted image output from the TAU 32 to the monitor 34 for display, and distributes the adjusted image to be output as a main video.

In the control system 11 illustrated in FIG. 10, a control signal corresponding to an operation of the operator VE on the controller 33 is not supplied to the video camera 21, and therefore the main video serves as the adjusted image adjusted by the TAU 32.

In the control system 11 of FIG. 10, the video camera 21 generates an adjusted image based on general camera adjustment value data for a captured image, and supplies the camera adjustment value data together with the adjusted image to the TAU 32, so that the captured image can be restored from the adjusted image by using the camera adjustment value data.

<Control Processing Performed by Control System of FIG. 10>

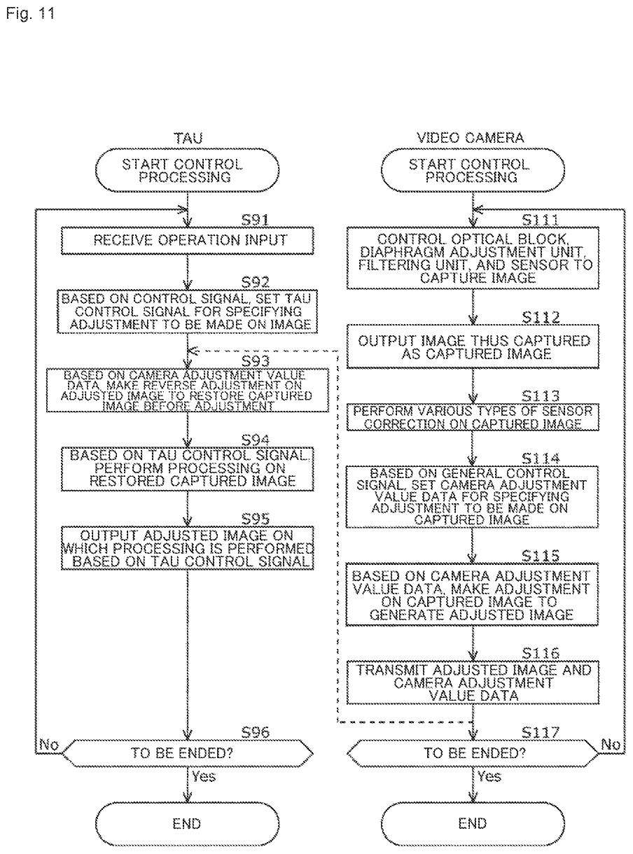

Next, control processing performed by the control system of FIG. 10 will be described with reference to the flowchart of FIG. 11.

The processing of steps S91 to S94 and S96 and the processing of steps S111 to S113 and S115 to S117 in the flowchart of FIG. 11 are the same as the processing of steps S11, S13, S14, S16, and S19 and the processing of steps S32 to S34 and S36 to S38 in the flowchart of FIG. 7, and therefore description thereof will be omitted.

Specifically, when no control signal is transmitted from the TAU 32 and no control signal is received by the video camera 21, the control unit 71″ generates a TAU control signal based on a control signal through the processing of steps S91 and S92, and outputs the TAU control signal to the adjustment unit 73.

When a captured image is captured and sensor correction is made on the captured image through the processing of steps S111 to S113, in step S114, the control unit 51′ sets, based on a general control signal, camera adjustment value data for setting adjustment details to be made on the captured image, and outputs the data to the adjustment unit 57.

Then, the adjusted image and the camera adjustment value data are transmitted to the TAU 32 through the processing of steps S115 and S116.

Through the processing in steps S93 and S94, based on the camera adjustment value data, the captured image is restored from the adjusted image, and based on the TAU control signal, an adjustment corresponding to the control signal is made on the restored captured image to generate an adjusted image, and the adjusted image is output to the distribution unit 31′.

In step S95, the distribution unit 31′ outputs the adjusted image to the monitor 34 for display.

The distribution unit 31′ distributes the adjusted image to be output as a main video.

Through the processing described above, the TAU 32 can restore the image captured by the video camera 21 even when no control signal is supplied from the TAU 32 to the video camera 21.

As a result, even when no control signal is supplied from the TAU 32 to the video camera 21, it is possible to improve the operability on the controller 33 for the operator VE.

### 5. Fourth Embodiment

An example has been described above in which no control signal is transmitted from the TAU 32 to the video camera 21.

However, even in a case where an adjusted image can be transmitted from the video camera 21 to the TAU 32 but camera adjustment value data cannot be transmitted, the captured image may be restored from the adjusted image by using a general TAU control signal based on the delay time.

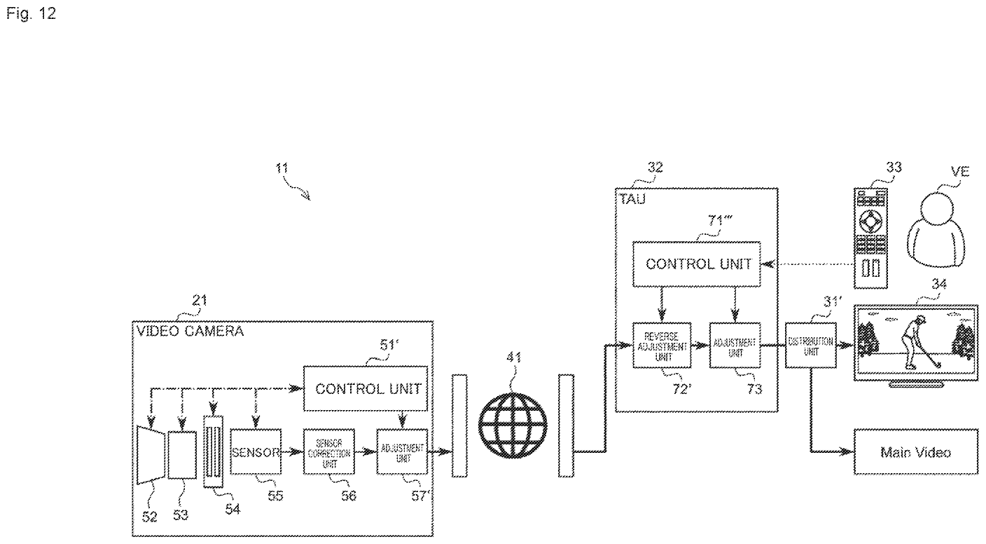

FIG. 12 illustrates a configuration example of a control system 11 having a configuration in which no control signal is supplied from the TAU 32 to the video camera 21 and an adjusted image can be transmitted from the video camera 21 to the TAU 32, but camera adjustment value data cannot be transmitted, or of the control system 11 in such a situation.

The control system 11 of FIG. 12 differs from the control system 11 of FIG. 4 in that the control unit 51′, the adjustment unit 57′, and the reverse adjustment unit 72′ of FIG. 8 are provided instead of the control unit 51, the adjustment unit 57, and the reverse adjustment unit 72, and a control unit 71′″ is provided instead of the control unit 71.

The control unit 71′″ has the same basic function as the control unit 71″ of FIG. 10, and differs in that it supplies a TAU control signal corresponding to a general control signal to the reverse adjustment unit 72′ according to the delay time.

Specifically, the control unit 71′″ outputs to the reverse adjustment unit 72′ a TAU control signal corresponding to a general control signal at the time going back by the delay time obtained in the processing of step S16 in the flowchart of FIG. 7.

No control signal is supplied from the TAU 32 to the video camera 21 and no camera adjustment value data is supplied from the video camera 21 to the TAU 32, but the reverse adjustment unit 72′ restores the captured image from the adjusted image by using the TAU control signal corresponding to a general control signal at the time going back by the delay time.

The distribution unit 31′ of the control system 11 of FIG. 12 is the same as the distribution unit 31′ of FIG. 10.

<Control Processing Performed by Control System of FIG. 12>

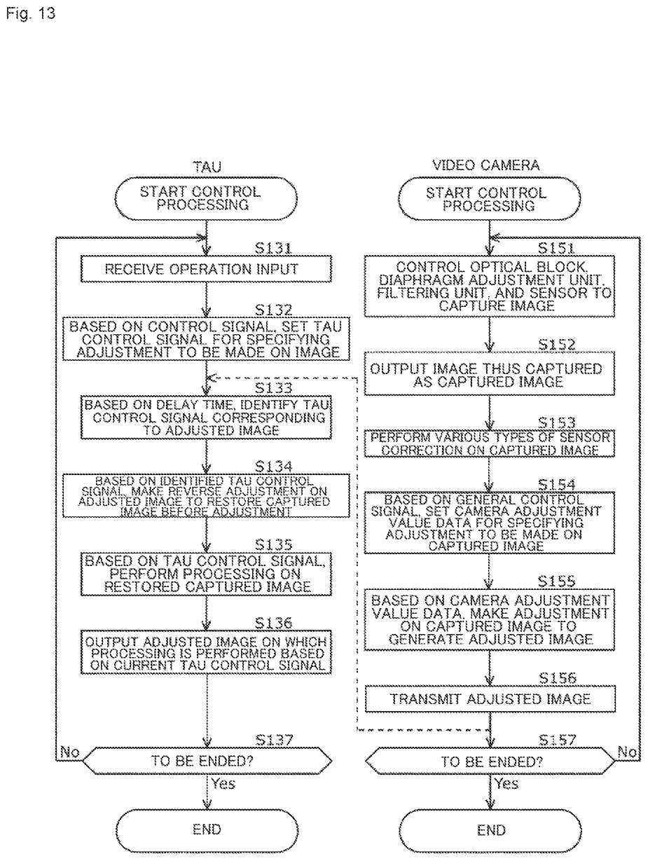

Next, control processing performed by the control system of FIG. 12 will be described with reference to the flowchart of FIG. 13.

The processing of steps S131, S132, and S135 to S137 and the processing of steps S111 to S117 in the flowchart of FIG. 13 are the same as steps S91 and S92 of FIG. 11, steps S94 to S96 of FIG. 9, and steps S111 to S117 of FIG. 11, and therefore description thereof will be omitted.

Specifically, through the processing of steps S131 and S132, a TAU control signal at the current timing is generated based on a control signal. Further, through the processing of steps S151 to S156, an adjusted image adjusted based on camera adjustment value data corresponding to a general control signal is transmitted from the video camera 21.

In step S133, the control unit 71′″ identifies a TAU control signal that specifies the adjustment details corresponding to the general control signal at the time going back by the delay time, and outputs the TAU control signal to the reverse adjustment unit 72′.

In step S134, based on the TAU control signal at the time going back by the delay time supplied from the control unit 71′″, the reverse adjustment unit 72′ makes the reverse adjustment on the adjusted image to restore the captured image, and outputs the captured image to the adjustment unit 73.

Through the processing in steps S135 and S136, the adjustment is made on the restored captured image based on the TAU control signal at the current timing, and the distribution unit 31 outputs the adjusted image to the monitor 34 for display, and distributes the adjusted image to be output as a main video.

Through the processing described above, the TAU 32 can restore the image captured by the video camera 21 even with a configuration in which no control signal is supplied from the TAU 32 to the video camera 21 and no camera adjustment value data is supplied from the video camera 21 to the TAU 32 or even in such a situation.

As a result, even with a configuration in which no control signal is supplied from the TAU 32 to the video camera 21 and no camera adjustment value data is supplied from the video camera 21 to the TAU 32, or even in such a situation, it is possible to improve the operability on the controller 33 for the operator VE.

### 6. First Application Example

An example has been described above in which a main video is output in a space where the operator VE who remotely controls the video camera 21 is located when viewed from the network 41.

However, the distribution unit may be provided in a space where the video camera 21 is located when viewed from the network 41, to output a main video.

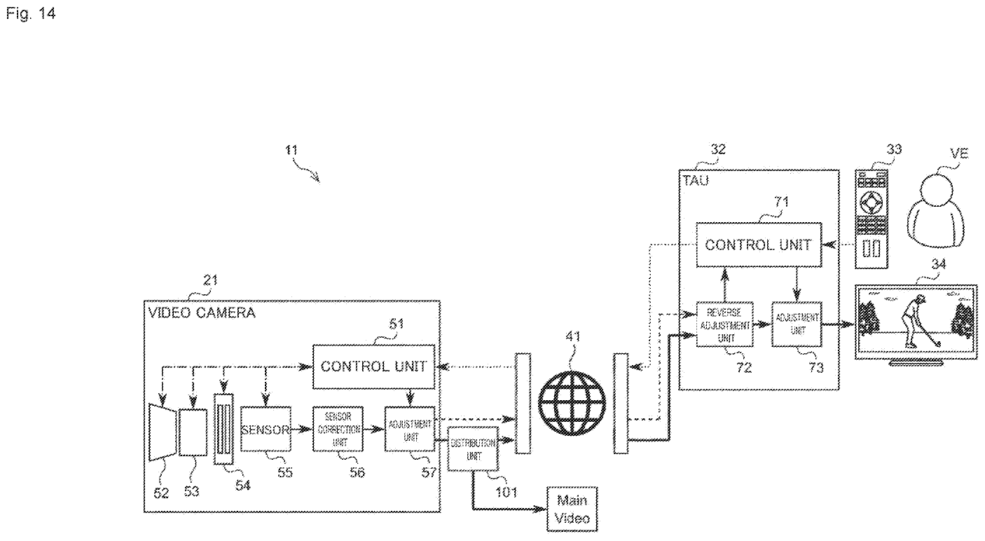

FIG. 14 illustrates a configuration example of a control system in which a distribution unit is provided in a space where the video camera 21 is located when viewed from the network 41.

The control system 11 of FIG. 14 differs from the control system 11 of FIG. 4 in that a distribution unit 101 is provided that distributes an image, which is output from the video camera 21, to be output as a main video, instead of the distribution unit 31.

Among the adjusted image and the camera adjustment value data, which are output from the video camera 21, the distribution unit 101 outputs the adjusted image to the TAU 32 via the network 41, and distributes the main video to be output.

With such a configuration, it is possible to output the main video to the vicinity of the video camera 21 provided at a remote location.

Even in such a configuration, it is possible to improve the operability on the controller 33 for the operator VE.

The control processing performed by the control system 11 of FIG. 14 is the same as the control processing performed by the control system 11 of FIG. 4 described with reference to the flowchart in FIG. 7, and therefore description thereof will be omitted.

### 7. Second Application Example

An example has been described above in which the configurations of the reverse adjustment unit 72 and the adjustment unit 73 in the TAU 32 are implemented by hardware. However, the configurations may be implemented by software.

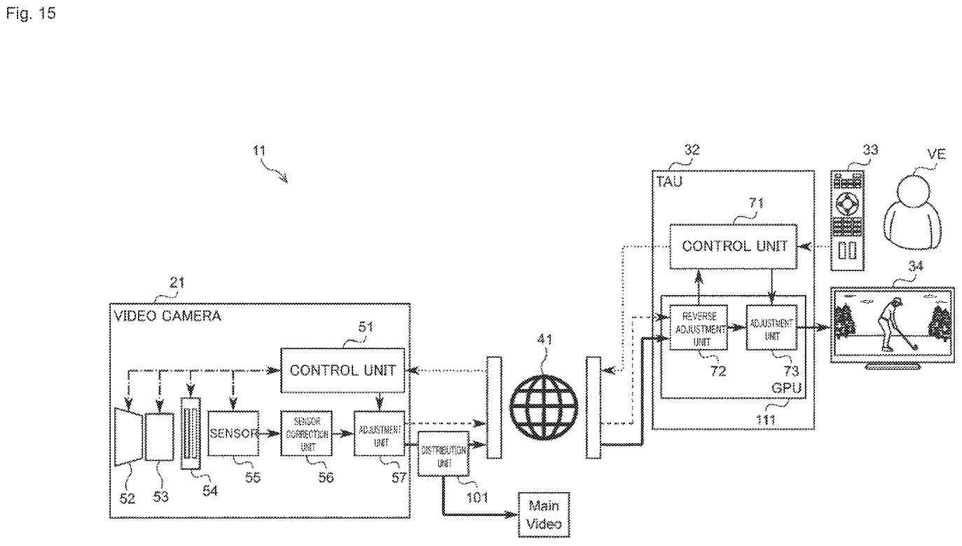

FIG. 15 illustrates a configuration example of a control system 11 in which the reverse adjustment unit 72 and the adjustment unit 73 are implemented by software.

In the control system 11 of FIG. 15, components having the same functions as those of the control system 11 of FIG. 14 are denoted by the same reference signs, and description thereof will be omitted as appropriate.

The control system 11 of FIG. 15 differs from the control system 11 of FIG. 14 in that the TAU 32 includes a graphics processing unit (GPU) 111, and the reverse adjustment unit 72 and the adjustment unit 73 are implemented by software executed by the GPU 111.

Even in such a configuration, it is possible to improve the operability on the controller 33 for the operator VE.

The control processing performed by the control system 11 of FIG. 15 is the same as the control processing performed by the control system 11 of FIG. 4 described with reference to the flowchart in FIG. 7, and therefore description thereof will be omitted.

### 8. Third Application Example

An example has been described above in which the control unit 71, the reverse adjustment unit 72, and the adjustment unit 73 of the TAU 32 are provided in the same configuration. However, the components may be provided in different configurations.

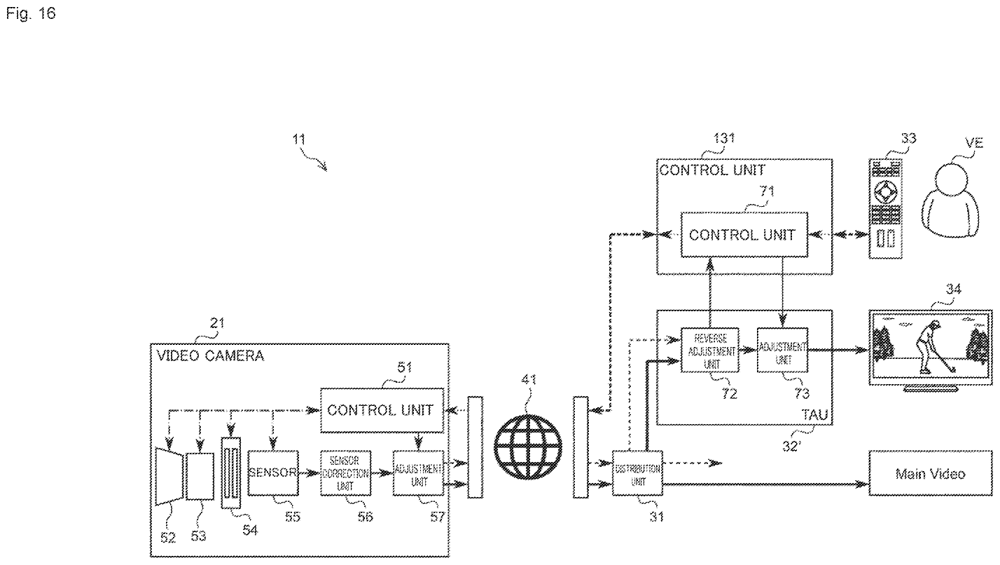

FIG. 16 illustrates a configuration example of a control system 11 in which the control unit 71, the reverse adjustment unit 72, and the adjustment unit 73 are separately configured.

In the control system 11 of FIG. 16, components having the same functions as those of the control system 11 of FIG. 4 are denoted by the same reference signs, and description thereof will be omitted as appropriate.

The control system 11 of FIG. 16 differs from the control system 11 of FIG. 4 in that the control unit 71 is provided in a single controlling unit 131 and operates integrally with a TAU 32′ including only the reverse adjustment unit 72 and the adjustment unit 73 to implement their functions.

In other words, in the control system 11 of FIG. 16, the controlling unit 131 provided with the control unit 71 and the TAU 32′ provided with the reverse adjustment unit 72 and the adjustment unit 73 are configured separately to implement the same functions as those of the control system 11 of FIG. 4 as a whole.

Even in such a configuration, it is possible to improve the operability on the controller 33 for the operator VE.

The control processing performed by the control system 11 of FIG. 16 is the same as the control processing performed by the control system 11 of FIG. 4 described with reference to the flowchart in FIG. 7, and therefore description thereof will be omitted.

### 9. Fourth Application Example

An example has been described above in which the controller 33 and the TAU 32 are configured to implement short-range communication such as infrared communication or Bluetooth (registered trademark) communication. However, the controller 33 and the TAU 32 may be configured to implement communication via a router such as a wireless LAN.

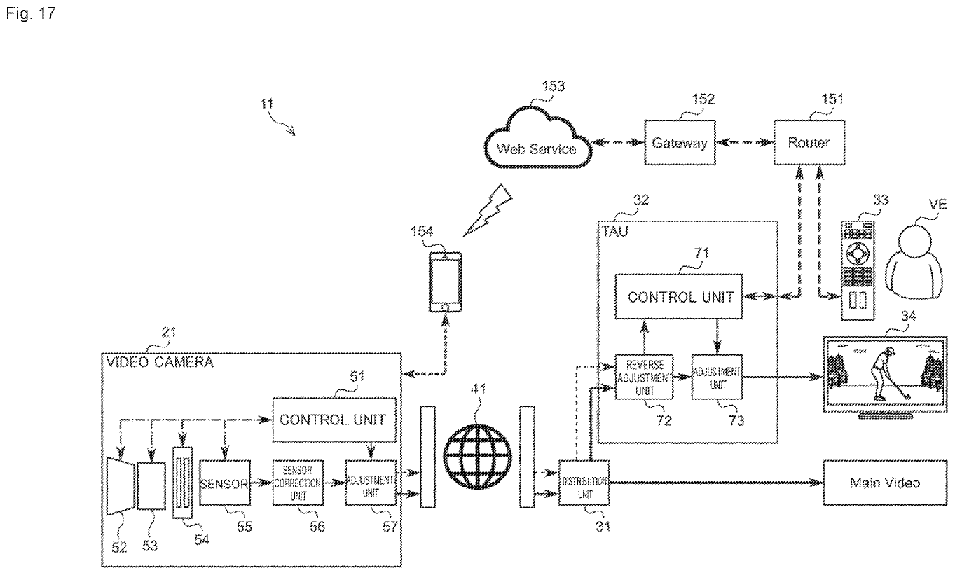

FIG. 17 illustrates a configuration example of a control system 11 in which the controller 33 and the TAU 32 are connected via a router such as a wireless LAN, and control signals are transmitted to the TAU 32 and the video camera 21 via web services.

In the control system 11 of FIG. 17, components having the same functions as those of the control system 11 of FIG. 4 are denoted by the same reference signs, and description thereof will be omitted as appropriate.

Specifically, the control system 11 of FIG. 17 differs from the control system of FIG. 4 in that the TAU 32 and the controller 33 are connected via a router 151. The control system 11 of FIG. 17 also differs in that control signals to be transmitted from the TAU 32 to the video camera 21 are transmitted via the router 151, a gateway 152, a web service 153, and a smartphone 154.

Except that the TAU 32 and the controller 33 are connected via the router 151 and control signals are transmitted from the TAU 32 via the router 151 through the smartphone 154, the control system 11 of FIG. 17 is the same as the control system 11 of FIG. 4, and therefore detailed description thereof will be omitted.

Even in such a configuration, it is possible to improve the operability on the controller 33 for the operator VE.

The control processing performed by the control system 11 of FIG. 17 is the same as the control processing performed by the control system 11 of FIG. 4 described with reference to the flowchart in FIG. 7, and therefore description thereof will be omitted.

### 10. Fifth Application Example

An example has been described above in which the TAU 32 and the controller 33 are implemented by hardware. However, the TAU 32 and the controller 33 may be implemented by software using a cloud computing system and/or a personal computer.

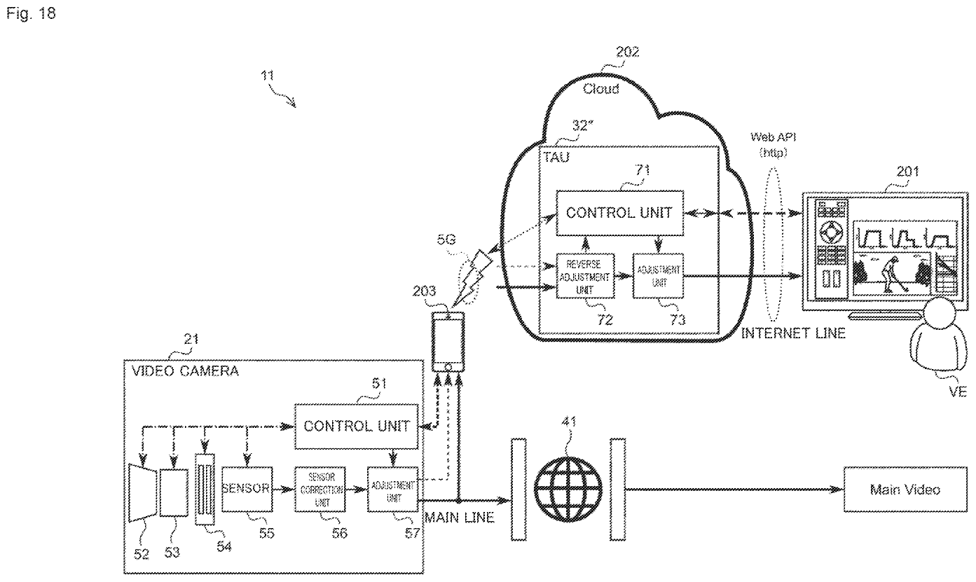

FIG. 18 illustrates a configuration example of a control system 11 in which the TAU 32 and the controller 33 are implemented by software using a cloud computing system and/or a personal computer.

In the control system 11 of FIG. 18, a personal computer 201 launches a web browser as software to function as the controller 33 and the monitor 34.

A cloud computing system (Cloud) 202 functions as a TAU 32″. Meanwhile, the personal computer 201 is connected to the TAU 32″ implemented by the cloud computing system (Cloud) 202 on the browser, for example, via an Internet line, to implement the functions of the controller 33 and the monitor 34.

The TAU 32″ and the video camera 21 are connected via a smartphone 203 via a high-speed line such as a 5G (5th Generation) line.

In other words, the control system 11 of FIG. 18 has the same basic functions as the control system 11 of FIG. 4 except that the personal computer 201 functions as the controller 33 and the monitor 34 to correspond to the TAU 32″ on the cloud computing 202.

Even in such a configuration, it is possible to improve the operability on the controller 33 for the operator VE.

The control processing performed by the control system 11 of FIG. 18 is the same as the control processing performed by the control system 11 of FIG. 4 described with reference to the flowchart in FIG. 7, and therefore description thereof will be omitted.

### 11. Fifth Embodiment

A case has been described above in which in the video camera 21, camera adjustment value data is set based on a control signal and an adjustment is made on a captured image based on the camera adjustment value data to generate an adjusted image, and in the TAU 32, the captured image is restored from the adjusted image by using a TAU control signal corresponding to the control signal.

Specifically, the TAU 32 makes, on an adjusted image in which an adjustment is made on a captured image captured in the video camera 21, the reverse adjustment to restore the captured image, and makes an adjustment on a control signal input in real time from the controller 33.

However, for example, in a case where optical adjustment values such as diaphragm adjustment and filter adjustment are set by the controller 33, the diaphragm adjustment unit 53 and the filtering unit 54 in the video camera 21 perform optical adjustment, while the TAU 32 includes no optical processing unit.

Thus, the TAU 32 cannot perform the reverse adjustment to the optical adjustment, so that the captured image cannot be optically restored.

Therefore, for example, in a case where optical adjustment values are set by the controller 33 and the diaphragm and filter are adjusted in the video camera 21, the TAU 32 may adjust the gains corresponding to the adjustment of the diaphragm and filter to provide a pseudo restoration of optical adjustment of a captured image.

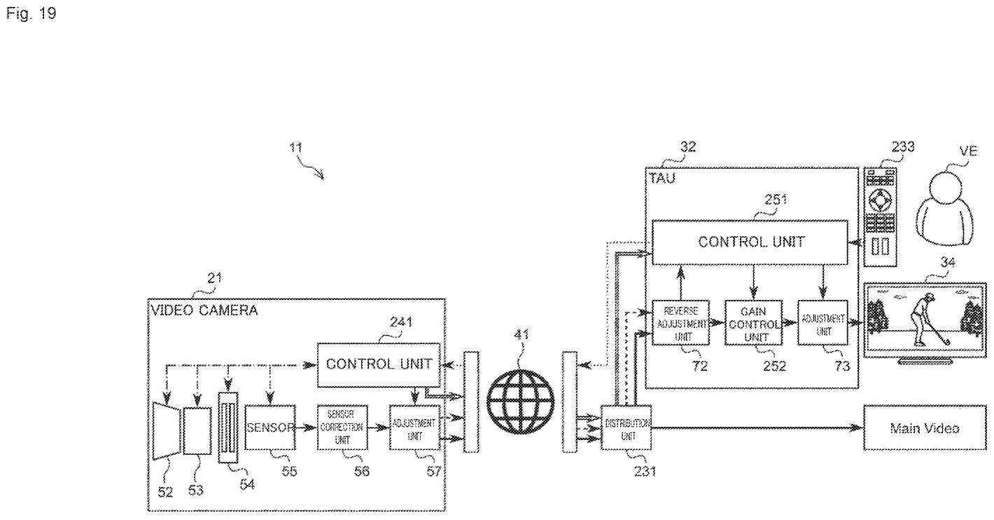

FIG. 19 illustrates a configuration example of a control system 11 in which in a case where optical adjustment values are set by the controller 33 and the diaphragm and filter are adjusted in the video camera 21, the TAU 32 adjusts the gains corresponding to the optical adjustment values to optically restore a captured image.

In the control system 11 of FIG. 19, components having the same functions as those of the control system 11 of FIG. 4 are denoted by the same reference signs, and description thereof will be omitted as appropriate.

Specifically, the control system 11 of FIG. 19 differs from the control system 11 of FIG. 4 in that a distribution unit 231, a controller 233, a control unit 241, and a control unit 251 are provided instead of the distribution unit 31, the controller 33, the control unit 51, and the control unit 71.

The control system 11 of FIG. 19 further includes a gain control unit 252, and the gain adjustment unit 80 which operates at the beginning stage in adjustment unit 73 can make an adjustment in consideration of the processing of the gain control unit 252. It replaces a functional unit that performs optical adjustments, the operation of which will be described below.

The distribution unit 231 has the same basic functions as the distribution unit 31, and further distributes, to the control unit 251, newly supplied camera optical adjustment value data in addition to the adjusted image and the camera adjustment value data.

The controller 233 basically has the same functions as the controller 33, and also outputs optical adjustment values for the video camera 21 as a further control signal to the TAU 32 in response to an operation input from the operator.

The optical adjustment values as used herein refer to adjustment values for controlling the optical adjustment mechanism, including an IRIS value for the diaphragm adjustment unit 53 and a filter adjustment value for the filtering unit 54.

The control unit 251 has the same basic functions as the control unit 71, and also transmits a control signal including optical adjustment values supplied from the controller 233 to the video camera 21 via the network 41.

The control unit 251 generates a TAU control signal based on the control signal including the optical adjustment values supplied from the controller 233, and outputs the TAU control signal to the adjustment unit 73.

Based on the optical adjustment values included in the control signal supplied from the controller 233 and the camera optical adjustment value data supplied from the video camera 21 via the distribution unit 231, the control unit 251 converts the difference between them into a video gain to set a gain control value, and outputs the gain control value to the gain control unit 252.

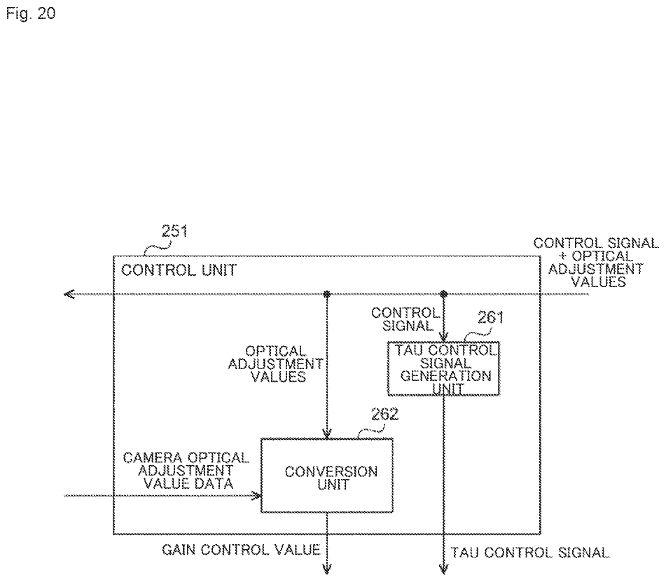

The detailed configuration of the control unit 251 will be described later in detail with reference to FIG. 20.

Based on the gain control value supplied from the control unit 251, the gain control unit 252 adjusts the gain for the restored captured image, other than the optical adjustment, on which the reverse adjustment unit 72 has made the reverse adjustment, to provide a pseudo optical reverse adjustment, and outputs the resulting restored captured image to the adjustment unit 73.

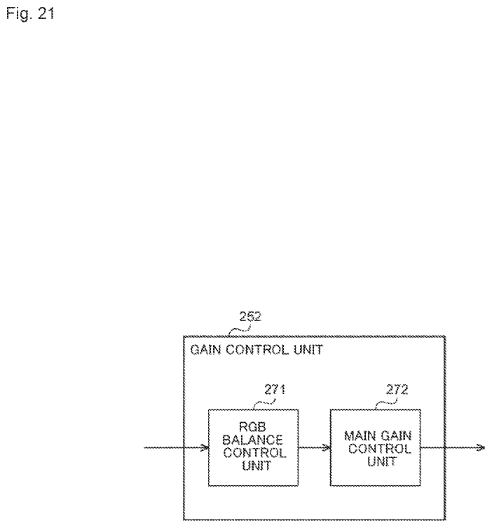

The configuration of the gain control unit 252 will be described later in detail with reference to FIG. 21.

The control unit 241 has the same basic functions as the control unit 51, and also adjusts the diaphragm adjustment unit 53 and the filtering unit 54 based on the optical adjustment values transmitted from the TAU 32 via the network 41.

When the adjusted image and the camera adjustment value data are transmitted from the adjustment unit 57 to the TAU 32, the control unit 241 transmits as camera optical adjustment value data an IRIS value and a filter adjustment value for adjusting the diaphragm adjustment unit 53 and the filtering unit 54, respectively, in addition to the adjusted image and the camera adjustment value data.

<Configuration Example of Control Unit in TAU of FIG. 19>

Next, a configuration example of the control unit 251 in the TAU 32 of FIG. 19 will be described with reference to FIG. 20.

The control unit 251 includes a TAU control signal generation unit 261 and a conversion unit 262.

The TAU control signal generation unit 261 basically has the same functions as the control unit 71, and also generates a TAU control signal based on the control signal including the optical adjustment values supplied from the controller 233, and outputs the TAU control signal to the adjustment unit 73.

Based on the optical adjustment values included in the control signal supplied from the controller 233 and the camera optical adjustment value data together with the adjusted image and the adjustment signal supplied from the video camera 21, the conversion unit 262 generates a gain control value and outputs the gain control value to the gain control unit 252.

More specifically, the conversion unit 262 converts the difference(s) between the optical adjustment values supplied from the controller 233 and the camera optical adjustment value data into a gain, and outputs the gain as a gain control value.

The conversion unit 262 also outputs a gain control value corresponding to the types of the optical adjustment values to the gain control unit 252.

Specifically, for the IRIS value for controlling the diaphragm adjustment unit 53 and the adjustment value for the variable neutral density (ND) filter in the filtering unit 54, which are included in the optical adjustment values, the conversion unit 262 outputs them as a main gain control value.

For the filter adjustment value for a color compensating (CC) filter in the filtering unit 54, which is included in the optical adjustment values, the conversion unit 262 outputs it as a gain adjustment value (RGB balance gain control value) for adjusting the RGB balance.

<Configuration Example of Gain Control Unit of FIG. 19>

Next, a configuration example of the gain control unit 252 of FIG. 19 will be described with reference to FIG. 21.

The gain control unit 252 includes an RGB balance control unit 271 and a main gain control unit 272.

The RGB balance control unit 271 adjusts the gain corresponding to the adjustment value for the CC filter in the filtering unit 54 based on the gain control value (RGB balance gain control value) supplied from the control unit 251, to make a pseudo optical reverse adjustment.

The main gain control unit 272 adjusts, based on the main gain control value supplied from the control unit 251, the gain corresponds to the IRIS value for controlling the diaphragm adjustment unit 53 and the adjustment value for the variable neutral density (ND) filter in the filtering unit 54, to make a pseudo optical reverse adjustment.

<Control Processing Performed by Control System of FIG. 19>

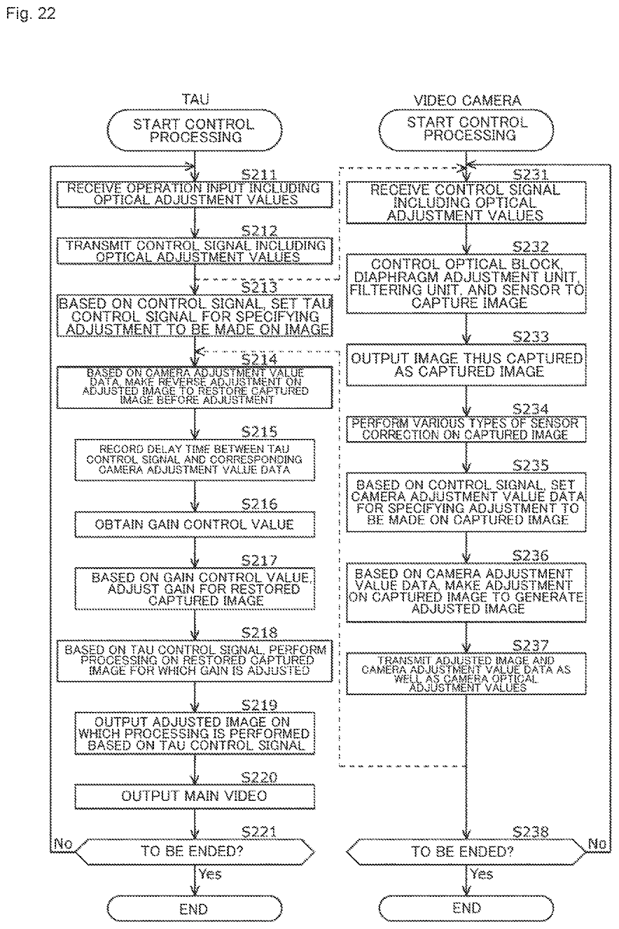

Next, control processing performed by the control system 11 of FIG. 19 will be described with reference to the flowchart of FIG. 22.

In step S211, in response to receiving an operation input from the operator VE, the controller 233 generates a control signal including optical adjustment values corresponding to the operation, and outputs the control signal to the TAU 32.

In step S212, the control unit 251 of the TAU 32 transmits the control signal, including optical adjustment values, supplied from the controller 233 to the video camera 21 via the network 41.

In step S213, the TAU control signal generation unit 261 of the control unit 251 generates a TAU control signal for setting adjustment details to be made on the image based on the control signal, and outputs the TAU control signal to the adjustment unit 73.

On the other hand, in step S231, the control unit 251 of the video camera 21 receives the control signal, including optical adjustment values, transmitted from the TAU 32 via the network 41.

In step S232, the control unit 251 controls the optical block 52, the diaphragm adjustment unit 53, the filtering unit 54, and the sensor 55 to capture an image.

Specifically, the control unit 251 adjusts the diaphragm of the diaphragm adjustment unit 53 based on the optical adjustment values, adjusts the CC filter and the ND filter of the filtering unit 54, and then captures an image with the sensor 55.

In step S233, the control unit 251 controls the sensor 55 to output the image thus captured as a captured image to the sensor correction unit 56.

In step S234, the sensor correction unit 56 performs flaw correction, noise suppression, shading correction, and the like on the captured image, and outputs the resulting image to the adjustment unit 57.

In step S235, based on the control signal supplied from the TAU 32, the control unit 251 sets camera adjustment value data for setting adjustment details to be made on the image, and outputs the data to the adjustment unit 57.

In step S236, based on the camera adjustment value data supplied from the control unit 51, the adjustment unit 57 makes on the corrected captured image an adjustment including black offset, compression, characteristic adjustment, and format conversion to generate an adjusted image.

In step S237, the adjustment unit 57 transmits the generated adjusted image together with the camera adjustment value data to the distribution unit 231 via the network 41.

Meanwhile, the control unit 251 transmits, as camera optical adjustment values together with the adjusted image and the camera adjustment value data, the IRIS value for the diaphragm adjustment unit 53 and the filter adjustment value for the filtering unit 54, which have been adjusted based on the optical adjustment values, to the distribution unit 231 via the network 41.

Among the transmitted adjusted image, camera adjustment value data, and camera optical adjustment values, the distribution unit 231 distributes the adjusted image to be output as a main video as it is.

The distribution unit 231 also supplies the adjusted image and the camera adjustment value data to the reverse adjustment unit 72 of the TAU 32 and outputs the camera optical adjustment value to the control unit 251.

In step S214, based on the camera adjustment value data, the reverse adjustment unit 72 of the TAU 32 makes on the adjusted image a reverse adjustment including reverse format conversion, reverse characteristic adjustment, decompression, and black offset removal to restore the captured image, and outputs the resulting captured image to the gain control unit 252.

On the captured image thus restored, the reverse adjustment to the optical adjustment for the diaphragm adjustment unit 53 and the filtering unit 54 has not been made.

In step S215, the control unit 251 obtains a delay time between the TAU control signal generated by the control unit 251 and the corresponding camera adjustment value data.

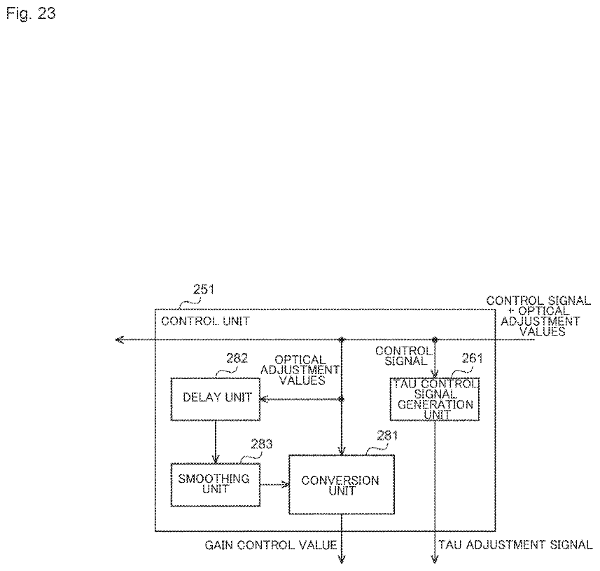

This delay time is not used in the control processing described with reference to the flowchart of FIG. 22, and therefore the processing of step S215 may be omitted. However, the delay time is information that can be used in a configuration described later with reference to FIG. 23, and is therefore given here as an example of a method of acquiring the delay time.

In step S216, based on the difference(s) between the optical adjustment values supplied from the controller 233 and the camera optical adjustment values supplied from the video camera 21 via the distribution unit 231, the conversion unit 262 of the control unit 251 obtains a gain control value and outputs the gain control value to the gain control unit 252.

The conversion unit 262 also outputs the main gain control value corresponding to the IRIS value for controlling the diaphragm adjustment unit 53 and the adjustment value for the variable ND filter in the filtering unit 54, and the RGB balance gain control value corresponding to the filter adjustment value for the CC filter in the filtering unit 54.

In step S217, the gain control unit 252 adjusts the gain for the restored captured image based on the gain control value and outputs the adjusted gain to the adjustment unit 73.

Thus adjusting the gain results in a restored captured image on which even the reverse adjustment to the optical adjustment has been made by the diaphragm adjustment unit 53 and the filtering unit 54.

In step S218, based on the TAU control signal, the adjustment unit 73 makes an adjustment on the restored captured image, for which the gain has been adjusted, to generate an adjusted image.

In step S219, the adjustment unit 73 outputs the adjusted image to the monitor 34 for display.

In step S220, the adjusted image, which is supplied from the video camera 21, distributed by the distribution unit 231 is output as a main video.

In steps S221 and S238, it is determined whether or not an instruction to end the processing has been given, and if no instruction to end the processing has been given, the processing returns to steps S211 and S231, respectively. Accordingly, until an instruction to end the processing is given, the TAU 32 including the distribution unit 231 repeats the processing of steps S211 to S222, and the video camera 21 repeats the processing of steps S231 to S238.

Then, in steps S221 and S238, if the instruction to end is given, the processing ends.

Through the above processing, when the operator VE performs an operation on the controller 233, a control signal, including optical adjustment values, corresponding to the operation is generated, supplied to the TAU 32, and supplied to the video camera 21 via the network 41. Meanwhile, the TAU 32 generates a TAU control signal based on the control signal.

In the video camera 21, the diaphragm adjustment unit 53 and the filtering unit 54 are adjusted based on the optical adjustment values, a captured image is captured, camera adjustment value data is generated based on the control signal, and an adjusted image is generated in which corresponding adjustment processing has been performed on the captured image.

Then, the adjusted image and the camera adjustment value data, which are generated by the video camera 21, and the camera optical adjustment values including the IRIS value for the diaphragm adjustment unit 53 and the filter adjustment value for the filtering unit 54 are transmitted to the TAU 32 via the network 41.

In the TAU 32, based on the camera adjustment value data, the reverse adjustment is made on the adjusted image generated by the video camera 21, and based on the optical adjustment values and the camera optical adjustment values, the gain is adjusted, so that the captured image is restored.

Then, an adjustment based on the TAU control signal is made on the restored captured image, and the resulting image is displayed on the monitor 34 as an adjusted image.

Thus, the TAU 32 makes it possible to make the adjustment, which is based on the TAU control signal corresponding to the control signal, including optical adjustment values, according to the operation on the controller 233, directly on the captured image (restored captured image) before being adjusted in the video camera 21.

As a result, a control signal, including optical adjustment values, generated by the operator VE operating the controller 233 is converted into a TAU control signal in the TAU 32, and the adjustment processing based on the TAU control signal is then performed directly on the captured image (restored captured image).

Further, even when the controller 233 is used to remotely control the video camera 21 via the network 41, the reduction in the operability due to delays and losses of control signals is suppressed in adjustments made on an image captured by the video camera 21, including optical adjustments.

As a result, even when the video camera 21 is remotely controlled via the network 41, the operator VE can operate the controller 233 while viewing the image captured by the video camera 21 on the monitor 34, thereby making an appropriate adjustment on the captured image.

### 12. First Modification Example of Fifth Embodiment

An example has been described above in which information on the camera optical adjustment values is supplied from the video camera 21, and the gain control value is obtained from the difference(s) between optical adjustment values from the controller 233 and the camera optical adjustment values in the conversion unit 262 of the control unit 251.

However, in the case where only the adjusted image is supplied from the video camera 21 as in the second embodiment described with reference to FIG. 8, the optical adjustment values may be delayed by a delay time, and then a difference(s) between the delayed optical adjustment values and real-time optical adjustment values may be converted into a gain to obtain a gain control value.

FIG. 23 illustrates a configuration example of a control unit 251 configured to after transmitting the control signal, delay the optical adjustment values supplied from the controller 233 by a delay time until an adjusted image is supplied from the video camera 21, and then to obtain a gain control value based on a difference(s) between the delayed optical adjustment values and real-time optical adjustment values.

In the control unit 251 of FIG. 23, components having the same functions as those of the control unit 251 of FIG. 19 are denoted by the same reference signs, and description thereof will be omitted as appropriate.

Specifically, the control unit 251 of FIG. 23 differs from the control unit 251 of FIG. 19 in that a conversion unit 281, a delay unit 282, and a smoothing unit 283 are provided instead of the conversion unit 262.

The delay unit 282 transmits the control signal, including the optical adjustment values, supplied from the controller 233, and then delays the optical adjustment values included in the control signal by a delay time until an adjusted image is supplied from the video camera 21, and outputs the delayed optical adjustment values to the smoothing unit 283.

The smoothing unit 283 adjusts in a smoothing manner the optical adjustment values supplied from the delay unit 282 so that the variation difference(s) between the delayed optical adjustment values and the optical adjustment values supplied in real time correspond to the mechanical variation(s) in the diaphragm adjustment unit 53 and the filtering unit 54, and outputs the resulting optical adjustment values to the conversion unit 281.

The conversion unit 281 converts the difference(s) between the optical adjustment values a predetermined delay time earlier from the delay unit 282 via the smoothing unit 283 and the optical adjustment values supplied from the controller 233 in real time into a gain to set a gain control value, and outputs the gain control value to the gain control unit 252.

Using the control unit 251 of FIG. 23 makes it possible to improve the operability in remote control including optical adjustment values even in a configuration in which only the adjusted image is supplied from the video camera 21 as in the second embodiment described with reference to FIG. 8.

The control processing using the control unit 251 of FIG. 23 includes the same basic processing as that of the control processing described with reference to the flowchart in FIG. 22, and therefore description thereof will be omitted.

### 13. Second Modification Example of Fifth Embodiment

A configuration example has been described above in which the video camera 21 includes the diaphragm adjustment unit 53, the filtering unit 54, and others. However, a configuration may be provided without an optical adjustment mechanism such as the diaphragm adjustment unit 53 and the filtering unit 54.

With such a configuration, a general video camera 21 may use a fixed IRIS value to capture an image or may use a shutter speed to adjust the IRIS value, but the above-described optical adjustment values do not allow optical adjustment.

Therefore, in a video camera 21 that does not have an optical adjustment mechanism, the adjustment of the shutter speed or the like may be disabled to use general preset values to capture an image and may use as camera optical adjustment values for the TAU 32 simulated reference values corresponding to the general preset values.

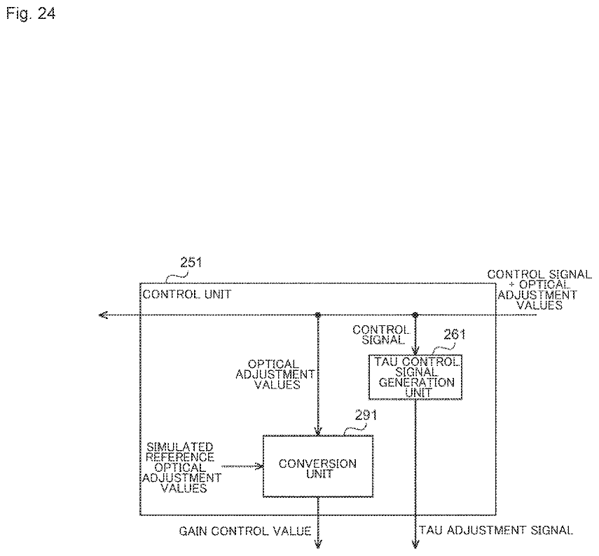

FIG. 24 illustrates a configuration example of a control unit 251 in which simulated reference values corresponding to general preset values are used as camera optical adjustment values.

In the control unit 251 of FIG. 24, components having the same functions as those of the control unit 251 of FIG. 19 are denoted by the same reference signs, and description thereof will be omitted as appropriate.

Specifically, the control unit 251 of FIG. 24 differs from the control unit 251 of FIG. 19 in that a conversion unit 291 is provided instead of the conversion unit 262.

The conversion unit 291 has the same basic function as the conversion unit 262, and converts difference(s) between simulated reference optical adjustment values corresponding to general preset values instead of the camera optical adjustment values and real-time optical adjustment values from the controller 233 into a gain to obtain a gain control value.

Even in a case where the control unit 251 of FIG. 24 remotely controls the video camera 21 that does not have an optical adjustment mechanism such as the diaphragm adjustment unit 53 and the filtering unit 54, it is possible to improve the operability in remote control including the optical adjustment values.

The control processing using the control unit 251 of FIG. 24 includes the same basic processing as that of the control processing described with reference to the flowchart in FIG. 22, and therefore description thereof will be omitted.

### 14. Software-performed Example

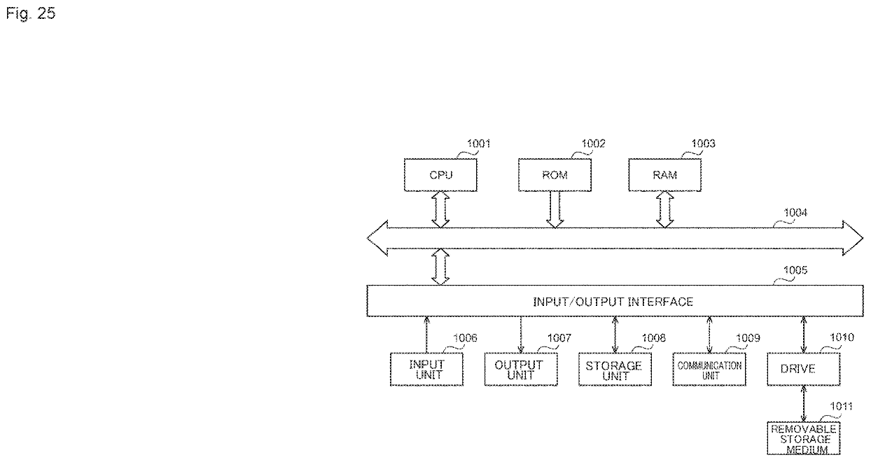

FIG. 25 illustrates a configuration example of a general-purpose computer. This personal computer includes a central processing unit (CPU) 1001 built therein. An input/output interface 1005 is connected to the CPU 1001 via a bus 1004. A read only memory (ROM) 1002 and a random access memory (RAM) 1003 are connected to the bus 1004.

An input unit 1006 including input devices such as a keyboard and a mouse for the user to input operation commands, an output unit 1007 that outputs a processing operation screen or an image of a processing result to a display device, a storage unit 1008 including, for example, a hard disk drive for storing programs and various data, and a communication unit 1009 that includes a local area network (LAN) adapter or the like and executes communication processing via a network represented by the Internet are connected to the input/output interface 1005. Further, a drive 1010 that reads and writes data from or to a magnetic disk (including a flexible disk), an optical disc (including a compact disc-read only memory (CD-ROM) or a digital versatile disc (DVD)), a magneto-optical disc (including a mini disc (MD)), or a removable storage medium 1011 such as a semiconductor memory is connected.

The CPU 1001 executes various types of processing according to a program stored in the ROM 1002, or a program read from the removable storage medium 1011 such as a magnetic disk, an optical disk, a magneto-optical disk, or a semiconductor memory, installed in the storage unit 1008, and loaded into the RAM 1003 from the storage unit 1008. The RAM 1003 also appropriately stores data and the like necessary for the CPU 1001 to execute various types of processing.

In the computer configured as described above, the CPU 1001 loads, for example, a program stored in the storage unit 1008 into the RAM 1003 via the input/output interface 1005 and the bus 1004, and executes the program so that the series of processing described above are performed.

A program to be executed by the computer (the CPU 1001) can be provided by being recorded on the removable storage medium 1011 such as a package medium, for example. The program can also be provided via a wired or wireless transmission medium such as a local area network, the Internet, or digital satellite broadcasting.

In the computer, the program can be installed in the storage unit 1008 via the input/output interface 1005 by the removable storage medium 1011 being mounted in the drive 1010. The program can be received by the communication unit 1009 via a wired or wireless transmission medium to be installed in the storage unit 1008. In addition, this program may be installed in advance in the ROM 1002 or the storage unit 1008.

The program to be executed by a computer may be a program that performs processing chronologically in the order described in the present specification or may be a program that performs processing in parallel or at a necessary timing such as a called time.

The CPU 1001 of FIG. 25 implements the functions of the control unit 51, the sensor correction unit 56, the adjustment unit 57, the control unit 71, the reverse adjustment unit 72, and the adjustment unit 73, which are illustrated in FIGS. 4 and 14 to 18. The CPU 1001 of FIG. 25 implements the functions of the control unit 51, the sensor correction unit 56, the adjustment unit 57′, the control unit 71′, the reverse adjustment unit 72′, and the adjustment unit 73, which are illustrated in FIG. 8. The CPU 1001 of FIG. 25 implements the functions of the control unit 51′, the sensor correction unit 56, the adjustment unit 57, the control unit 71″, the reverse adjustment unit 72, and the adjustment unit 73, which are illustrated in FIG. 10. The CPU 1001 of FIG. 25 implements the functions of the control unit 51′, the sensor correction unit 56, the adjustment unit 57′, the control unit 71′″, the reverse adjustment unit 72′, and the adjustment unit 73, which are illustrated in FIG. 12. The CPU 1001 of FIG. 25 implements the functions of the control unit 241, the sensor correction unit 56, the adjustment unit 57, the control unit 251, the reverse adjustment unit 72, the gain control unit 252, and the adjustment unit 73, which are illustrated in FIG. 19.

In the present specification, the system means a set of a plurality of components (devices, modules (parts), or the like), and it does not matter whether or not all the components are in the same housing. Therefore, a plurality of devices housed in separate housings and connected via a network, and one device housing a plurality of modules in one housing, are both systems.

Note that embodiments of the present disclosure are not limited to the above-described embodiments and can be modified in various manners without departing from the scope and spirit of the present disclosure.

For example, the present disclosure may be configured as cloud computing in which a plurality of devices share and cooperatively process one function via a network.

In addition, each step described in the above flowchart can be executed by one device or executed in a shared manner by a plurality of devices.

Further, when a plurality of steps of processing are included in one step, the plurality of steps of processing included in the one step may be performed by one device or may be shared and performed by a plurality of devices.

The present disclosure can also be configured as follows.

<1> An information processing device including:
a reverse adjustment unit that makes on an adjusted image in which an adjustment is made on a captured image captured by an imaging device for capturing the captured image, a reverse adjustment to the adjustment to restore the captured image before the adjustment; and
an adjustment unit that makes an adjustment on the restored captured image.

<2> The information processing device according to <1>, wherein in consideration of a delay time until the adjusted image is transmitted from the imaging device via a network, the reverse adjustment unit makes on the adjusted image on which the adjustment is made a reverse adjustment to the adjustment to restore the captured image before the adjustment.

<3> The information processing device according to <2>, wherein the reverse adjustment unit acquires together with the adjusted image from the imaging device an adjustment signal indicating adjustment details made on the adjusted image, and makes the reverse adjustment based on the adjustment signal on the adjusted image to restore the captured image.

<4> The information processing device according to <1>, further comprising a control unit that receives an input of a control signal for remotely controlling the imaging device and transmits the control signal to the imaging device, wherein the reverse adjustment unit makes a reverse adjustment to the adjustment on an adjusted image on which an adjustment corresponding to the control signal is made in the imaging device to restore the captured image before the adjustment, and the adjustment unit makes an adjustment corresponding to the control signal on the restored captured image.

<5> The information processing device according to <4>, wherein
the imaging device generates based on the control signal an adjustment signal for specifying adjustment details for the captured image, and makes the adjustment on the captured image based on the adjustment signal, and the reverse adjustment unit acquires together with the adjusted image from the imaging device an adjustment signal indicating adjustment details made on the adjusted image, and makes the reverse adjustment based on the adjustment signal on the adjusted image on which the adjustment is made, to restore the captured image.

<6> The information processing device according to <1>, further comprising a gain control unit that controls, according to an adjustment state of an optical adjustment unit that adjusts an optical brightness for the imaging device to capture the captured image, a gain for the captured image restored by the reverse adjustment unit.

<7> The information processing device according to <6>, further comprising a control unit that receives an input of a control signal for remotely controlling the imaging device and an input of an optical adjustment value for specifying the adjustment state of the optical adjustment unit, and transmits the inputs to the imaging device, wherein
the reverse adjustment unit makes a reverse adjustment to the adjustment on an adjusted image on which an adjustment corresponding to the control signal is made in the imaging device to restore the captured image before the adjustment, and the gain control unit controls the gain for the captured image restored by the reverse adjustment unit according to the adjustment state of the optical adjustment unit corresponding to the optical adjustment value, and
the adjustment unit makes an adjustment corresponding to the control signal on the restored captured image for which the gain is controlled by the gain control unit.

<8> The information processing device according to <7>, wherein
the imaging device generates based on the optical adjustment value an imaging optical adjustment value for specifying adjustment details of the optical adjustment unit, and adjusts the optical adjustment unit based on the imaging optical adjustment value,
the control unit sets a gain control value for controlling the gain based on the imaging optical adjustment value corresponding to the captured image and the input optical adjustment value, and the gain control unit controls the gain for the captured image restored by the reverse adjustment unit based on the gain control value.

<9> The information processing device according to <8>, wherein the control unit sets the gain control value based on a difference between the imaging optical adjustment value corresponding to the captured image and the input optical adjustment value.

<10> The information processing device according to <8>, wherein the control unit sets the gain control value based on a difference between a predetermined simulated reference value for the imaging optical adjustment value and the input optical adjustment value.

<11> The information processing device according to <8>, wherein the control unit sets the gain control value based on a difference between the input optical adjustment value and the optical adjustment value input a delay time earlier, the delay time being until the adjusted image is transmitted from the imaging device via a network.

<12> The information processing device according to <11>, wherein the optical adjustment value input the delay time earlier is smoothed according to a mechanical operation of the optical adjustment unit.

<13> The information processing device according to <6>, wherein the optical adjustment unit includes a diaphragm adjustment unit that adjusts a diaphragm for incident light when the captured image is captured, and a filtering unit that performs filtering on the incident light.

<14> The information processing device according to <13>, wherein the filtering unit includes a variable neutral density (ND) filter and a color compensating (CC) filter.

<15> The information processing device according to <14>, wherein the gain control unit controls a main gain according to an adjustment state of the diaphragm adjustment unit and the variable neutral density (ND) filter, and controls white balance in the gain according to an adjustment state of the color compensating (CC) filter.

<16> The information processing device according to any one of <1> to <15>, wherein the reverse adjustment unit and the adjustment unit include black offset, high luminance compression, luminance adjustment based on a transfer function, and adjustment related to format conversion.

<17> The information processing device according to any one of <1> to <16>, wherein the reverse adjustment unit and the adjustment unit are implemented by a graphical processing unit (GPU) or a cloud computing system.

<18> An information processing method including the steps of:
making on an adjusted image in which an adjustment is made on a captured image captured by an imaging device for capturing the captured image, a reverse adjustment to the adjustment to restore the captured image before the adjustment; and
making an adjustment on the restored captured image.

<19> A program causing a computer to function as:
a reverse adjustment unit that makes on an adjusted image in which an adjustment is made on a captured image captured by an imaging device for capturing the captured image, a reverse adjustment to the adjustment to restore the captured image before the adjustment; and
an adjustment unit that makes an adjustment on the restored captured image.

### REFERENCE SIGNS LIST

11 Control system
21 Video camera
31, 31′ Distribution unit
32, 32′, 32″, 32′″ TAU
33 Control unit
34 Monitor
41 Network
51, 51′, 51″ Control unit
52 Optical block
53 Diaphragm adjustment unit
54 Filtering unit
55 Sensor
56 Sensor correction unit
57, 57′ Adjustment unit
71, 71′, 71″, 71′″ Control unit
72, 72′ Reverse adjustment unit
73 Adjustment unit
81 Black correction unit
82 Compression unit
83 Characteristic adjustment unit
84 Format conversion unit
91 Reverse format conversion unit
92 Reverse characteristic adjustment unit
93 Decompression unit
94 Reverse black correction unit
101 Distribution unit
111 GPU
131 Controlling unit
151 Router
152 Gateway
153 Web service
154 Smartphone
201 Personal computer
202 Cloud computing system
203 Smartphone
231 Distribution unit
233 Controller
241 Control unit
251 Control unit
252 Gain control unit
261 TAU control signal generation unit
262 Conversion unit
271 RGB balance control unit
272 Main gain control unit
281 Conversion unit
282 Delay unit
283 Smoothing unit
291 Conversion unit

1. An information processing device comprising:
a reverse adjustment unit that makes on an adjusted image in which an adjustment is made on a captured image captured by an imaging device for capturing the captured image, a reverse adjustment to the adjustment to restore the captured image before the adjustment; and
an adjustment unit that makes an adjustment on the restored captured image.

2. The information processing device according to claim 1, wherein in consideration of a delay time until the adjusted image is transmitted from the imaging device via a network, the reverse adjustment unit makes on the adjusted image on which the adjustment is made a reverse adjustment to the adjustment to restore the captured image before the adjustment.

3. The information processing device according to claim 2, wherein the reverse adjustment unit acquires together with the adjusted image from the imaging device an adjustment signal indicating adjustment details made on the adjusted image, and makes the reverse adjustment based on the adjustment signal on the adjusted image to restore the captured image.

4. The information processing device according to claim 1, further comprising a control unit that receives an input of a control signal for remotely operating the imaging device and transmits the control signal to the imaging device, wherein
the reverse adjustment unit makes a reverse adjustment to the adjustment on an adjusted image on which an adjustment corresponding to the control signal is made in the imaging device to restore the captured image before the adjustment, and the adjustment unit makes an adjustment corresponding to the control signal on the restored captured image.

5. The information processing device according to claim 4, wherein
the imaging device generates based on the control signal an adjustment signal for specifying adjustment details for the captured image, and makes the adjustment on the captured image based on the adjustment signal, and
the reverse adjustment unit acquires together with the adjusted image from the imaging device an adjustment signal indicating adjustment details made on the adjusted image, and makes the reverse adjustment based on the adjustment signal on the adjusted image on which the adjustment is made, to restore the captured image.

6. The information processing device according to claim 1, further comprising a gain control unit that controls, according to an adjustment state of an optical adjustment unit that adjusts an optical brightness for the imaging device to capture the captured image, a gain for the captured image restored by the reverse adjustment unit.

7. The information processing device according to claim 6, further comprising a control unit that receives an input of a control signal for remotely controlling the imaging device and an input of an optical adjustment value for specifying the adjustment state of the optical adjustment unit, and transmits the inputs to the imaging device, wherein
the reverse adjustment unit makes a reverse adjustment to the adjustment on an adjusted image on which an adjustment corresponding to the control signal is made in the imaging device to restore the captured image before the adjustment, and
the gain control unit controls the gain for the captured image restored by the reverse adjustment unit according to the adjustment state of the optical adjustment unit corresponding to the optical adjustment value, and
the adjustment unit makes an adjustment corresponding to the control signal on the restored captured image for which the gain is controlled by the gain control unit.

8. The information processing device according to claim 7, wherein
the imaging device generates based on the optical adjustment value an imaging optical adjustment value for specifying adjustment details of the optical adjustment unit, and adjusts the optical adjustment unit based on the imaging optical adjustment value,
the control unit sets a gain control value for controlling the gain based on the imaging optical adjustment value corresponding to the captured image and the input optical adjustment value, and
the gain control unit controls the gain for the captured image restored by the reverse adjustment unit based on the gain control value.

9. The information processing device according to claim 8, wherein the control unit sets the gain control value based on a difference between the imaging optical adjustment value corresponding to the captured image and the input optical adjustment value.

10. The information processing device according to claim 8, wherein the control unit sets the gain control value based on a difference between a predetermined simulated reference value for the imaging optical adjustment value and the input optical adjustment value.

11. The information processing device according to claim 8, wherein the control unit sets the gain control value based on a difference between the input optical adjustment value and the optical adjustment value input a delay time earlier, the delay time being until the adjusted image is transmitted from the imaging device via a network.

12. The information processing device according to claim 11, wherein the optical adjustment value input the delay time earlier is smoothed according to a mechanical operation of the optical adjustment unit.

13. The information processing device according to claim 6, wherein the optical adjustment unit includes a diaphragm adjustment unit that adjusts a diaphragm for incident light when the captured image is captured, and a filtering unit that performs filtering on the incident light.

14. The information processing device according to claim 13, wherein the filtering unit includes a variable neutral density (ND) filter and a color compensating (CC) filter.

15. The information processing device according to claim 14, wherein the gain control unit controls a main gain according to an adjustment state of the diaphragm adjustment unit and the variable neutral density (ND) filter, and controls white balance in the gain according to an adjustment state of the color compensating (CC) filter.

16. The information processing device according to claim 1, wherein the reverse adjustment unit and the adjustment unit include black offset, high luminance compression, luminance adjustment based on a transfer function, and adjustment related to format conversion.

17. The information processing device according to claim 1, wherein the reverse adjustment unit and the adjustment unit are implemented by a graphical processing unit (GPU) or a cloud computing system.

18. An information processing method comprising the steps of:
making on an adjusted image in which an adjustment is made on a captured image captured by an imaging device for capturing the captured image, a reverse adjustment to the adjustment to restore the captured image before the adjustment; and
making an adjustment on the restored captured image.

19. A program causing a computer to function as:
a reverse adjustment unit that makes on an adjusted image in which an adjustment is made on a captured image captured by an imaging device for capturing the captured image, a reverse adjustment to the adjustment to restore the captured image before the adjustment; and
an adjustment unit that makes an adjustment on the restored captured image.
